(19) United States
(12) Patent Application Publication
(10) Pub. No.: US 2026/0021962 A1
(43) Pub. Date: Jan. 22, 2026

(54) A CRANE TROLLEY ASSEMBLY, A CRANE AND A SYSTEM COMPRISING THE ASSEMBLY AND ASSOCIATED METHODS

(71) Applicant: AutoStore Technology AS, Nedre Vats (NO)

(72) Inventors: Kenneth MÜLLER, Vormedal (NO); Geir VIKINGSTAD, Haugesund (NO)

(21) Appl. No.: 18/875,708

(22) PCT Filed: Aug. 21, 2023
(86) PCT No.: PCT/EP2023/072926

§ 371 Date: Dec. 16, 2024

(30) Foreign Application Priority Data
Aug. 30, 2022 (NO) 20220933

(51) Int. Cl. B65G 1/04; B66C 13/06; B66C 17/00

(52) U.S. Cl. CPC B65G 1/0464; B66C 13/06; B66C 17/00

(57) ABSTRACT

The invention relates to a crane trolley assembly (604′,604″,604″′) comprising: —a crane trolley (603a,603b,603c,603d,603e,603f) configured for guided movement along a beam (601,602) of a crane (600); —a lifting frame (504) configured for connection to a storage container (106) to lift the storage container (106) from above through a first vertical movement range (R1) and a second vertical movement range (R2) of the lifting frame (504); —a plurality of lifting members (505) suspending the lifting frame (504) below the crane trolley (603a,603b,603c,603d,603e,603f) for lifting and lowering the lifting frame (504) through at least the second vertical movement range (R2); and —a stabilizer (620′,620″,620″′) extending below the crane trolley (603a,603b,603c,603d,603e, 603f); wherein a lower end (620L′,620L″,620L″′) of the stabilizer (620′,620″,620″′) is configured to interact with the lifting frame (504) in order to stabilize the lifting frame (504) during the first vertical movement range (R1) of the lifting frame (504), and wherein the stabilizer (620′,620″,620″′) and the lifting frame (504) are configured to move vertically relative each other when in the second vertical movement range (R2) of the lifting frame (504). The invention further relates to an associated automated storage and retrieval system and methods of transferring a storage container.

The invention relates to a crane trolley assembly and an associated automated storage and retrieval system and methods transferring a storage container.

### BACKGROUND AND PRIOR ART

FIG. 1 discloses a prior art automated storage and retrieval system 1 with a frame structure 100 and FIGS. 2, 3 and 4 disclose three different prior art container handling vehicles 201,301,401 suitable for operating on such a system 1.

The frame structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The frame structure 100 of the automated storage and retrieval system 1 comprises a rail system 108 arranged across the top of frame structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of parallel rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the frame structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set of parallel rails 110, and the second set of wheels 201c,301c,401c is arranged to engage with two adjacent rails of the second set of parallel rails 111. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of parallel rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may comprise a lifting frame 404d suspended from lifting bands 404a. The lifting bands 404a may provide power and communication between the container handling vehicle and the lifting frame 404d. The lifting frame 404d may comprise gripping engaging devices/grippers 404b for connection to gripping recesses of a storage container 106. Guide pins 404c assist in aligning the grippers 404b relative the gripping recesses of the storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the frame structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the frame structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the frame structure 100 or transferred out of or into the frame structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the frame structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a drop-off port column where the container handling vehicles 201,301,401 can drop off storage containers 106 to be transported to an access or a transfer station, and the second port column 120 may be a pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the frame structure 100 again once accessed. A port can also be used for transferring storage containers to another storage facility (e.g. to another frame structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different frame structures, e.g. as is described in WO2014/075937A1, the contents of which are incorporated herein by reference.

A storage system may also use port columns 119,120 to transfer a storage container between the rail system 108 on top of the frame structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the frame structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

An objective of the invention is to provide a solution for continuous guiding of a lifting frame of a crane trolley assembly.

### SUMMARY OF THE INVENTION

The present invention is set forth and characterized in the independent claims, while the dependent claims describe other characteristics of the invention.

It is described a guiding solution ensuring that the lifting frame suspended from a crane trolley assembly is always guided preventing or minimizing horizontal movement. The solution has a first vertical movement range and a second vertical movement range.

For example, if the crane trolley assembly is arranged above a rail system of an automated storage and retrieval system, guiding of the lifting frame is also ensured when the lifting frame is above the rail system. The first vertical movement range may be above the rail system and the second vertical movement range may be below the rail system guiding against upright members of a frame structure, where the upright members may be arranged in each corner of the lifting frame.

The present invention relates to a crane trolley assembly comprising:
a crane trolley configured for guided movement along a beam of a crane;
a lifting frame configured for connection to a storage container to lift the storage container from above through a first vertical movement range and a second vertical movement range of the lifting frame;
a plurality of lifting members suspending the lifting frame below the crane trolley for lifting and lowering the lifting frame through at least the second vertical movement range; and
a stabilizer extending below the crane trolley;

wherein a lower end of the stabilizer is configured to interact with the lifting frame in order to stabilize the lifting frame during the first vertical movement range of the lifting frame, and wherein the stabilizer and the lifting frame are configured to move vertically relative each other when in the second vertical movement range of the lifting frame.

The distance between the stabilizer and the lifting frame increases when the lifting frame continues to move vertically below a reach of the lower end of the stabilizer.

The lifting members may be lifting bands. Alternatively, the lifting members may be wire or rope.

The stabilizer may have a maximum reach which is shorter than the maximum reach of the lifting members.

The stabilizer can be seen as a guide or guide arm.

The first and second vertical movement ranges may be subsequent movement ranges, i.e. the second vertical movement range succeeds the first vertical movement range, and vice versa. In other words, the first and second vertical movement range do not overlap each other. The first vertical movement range starts at the crane trolley and extends a first distance downwards, whereas the second vertical movement range starts where the first distance ends and extends a second distance downwards.

The stabilizer may be configured to stabilize the lifting and lowering of the lifting frame by guiding movement of the lifting frame in a vertical direction below the crane trolley while restricting horizontal movement of the lifting frame during the first vertical movement range of the lifting frame when the lower end of the stabilizer interacts with the lifting frame.

The lifting frame may be rectangular and comprise guides at corners of the lifting frame for guiding the lifting frame within storage columns of a frame structure of an automated storage and retrieval system during the second vertical movement range.

The beam may be a first beam extending in a first direction or a second beam extending in a second direction perpendicular to the first direction, and the crane trolley may be movable along the first beam and/or the second beam.

The crane trolley may comprise a first lateral movement arrangement for movement along the first beam and/or the second beam.

The crane trolley may thus be movable in a horizontal plane along the first beam and/or the second beam.

The lateral movement arrangement may be different arrangements such as, but not limited to, a rack-and-pinion arrangement or wheel(s) on the crane trolley running along the first beam and/or the second beam.

The stabilizer may comprise an extendable mechanism for moving the lower end relative the crane trolley.

The extendable mechanism can be a telescopic mechanism where a major part of the extension and retraction occurs at or below the crane trolley.

The stabilizer may extend through the crane trolley. I.e. the stabilizer may have a fixed length and at least a portion of the stabilizer may be vertically movable between a position above the crane trolley and a position below the crane trolley.

The plurality of lifting members may be arranged to wind onto and off spools. While the spools may be arranged in one end of the lifting members, the lifting frame may be arranged in an opposite end of the lifting members. The spools may function as lifting shafts. Alternatively, lifting shafts may be arranged between the spools and the lifting frame for ensuring proper guiding of the lifting members and thus the lifting frame.

In a first embodiment, spools may be positioned at the crane trolley. In this embodiment, the lifting members extend from the crane trolley to the lifting frame and provides all vertical movement of the lifting frame. I.e. the lifting members ensure vertical movement of the lifting frame and the stabilizer even in the first vertical movement range. The stabilizer may as such be passive during vertical movement but sufficiently stiff or rigid horizontally to guide the lifting frame in the first vertical movement range. The stabilizer may have different embodiments, such as a telescopic solution connected to the crane trolley or of a fixed length movable vertically through or adjacent the crane trolley dependent on the position of the lifting frame. If the lifting frame is in an upper part of the first vertical movement range (e.g. docked in an upper position towards the crane trolley), the stabilizer may extend up and above the crane trolley, whereas if the lifting frame is in the second vertical movement range the stabilizer is below the crane trolley.

In the solution where the spools are arranged at the crane trolley, the stabilizer is arranged between the lifting members.

In the first embodiment, the lower end of the stabilizer is preferably fixedly connected to the stabilizer. I.e. the lower end of the stabilizer follows any movement of the stabilizer.

Furthermore, the lifting frame may be provided with a socket to locate the lower end of the stabilizer, whereby sides of the socket engaging with the lower end of the stabilizer may restrict horizontal movement of the lifting frame during the first vertical movement range.

The lower end of the stabilizer may be arranged to engage with the socket of the lifting frame.

In a second embodiment, the spools may be positioned at the lower end of the stabilizer. As such, in contrast to the first embodiment, the lifting members do not extend from the crane trolley but is rather connected to the lower end of the stabilizer. Other components such as lifting shaft(s), lifting motor etc. may also be arranged at the lower end of the stabilizer.

In this second embodiment, the lower end of the stabilizer is preferably fixedly connected to the stabilizer. I.e. the lower end of the stabilizer follows any movement of the stabilizer.

In a third embodiment, the lower end of the stabilizer is rotatably connected to the stabilizer. I.e. the lower end of the stabilizer may rotate relative the stabilizer.

As such, the lower end of the stabilizer may comprise a rotation device for rotating the lower end of the stabilizer relative the stabilizer.

The rotation device can be connected to a gear arrangement or similar for rotating the lower end of the stabilizer.

According to the second and third embodiment, the extendable mechanism of the stabilizer can be a telescopic mechanism where the stabilizer is formed of sections which can collapse into each other and/or a rack-and-pinion arrangement where the stabilizer is e.g. a rod or beam of a fixed length which can be moved from a lower end of the crane trolley to and upper end of the crane trolley. In either case of the stabilizer according to the second and third embodiment, the stabilizer is actively moving the lower end of the stabilizer relative the crane trolley compared to the first embodiment where the stabilizer passively follows the winding up or spooling out of the lifting frame. According to the second and third embodiment, the stabilizer may be driven up and down by a stabilizer motor arranged at the crane trolley. Independent drive of the stabilizer provides for the possibility of increased acceleration of the lower end of the stabilizer, and thus the lifting frame, compared to the acceleration caused by gravity alone.

Alternatively, according to the second and third embodiment, the extendable mechanism may be formed by rigid-chain actuators. Rigid chain actuators work by pairing a drive (usually an electric motor) with a length of chain sporting shoulders on each link. The motor output shaft-fitted with a specialty sprocket or pinion-applies tangential force to the chain. Then the chain comes out and straightens, and its links' shoulders lock to form a rigid series. When the motor runs in the opposite direction, the chain shoulders disengage and allow for coiling.

It is further described a crane comprising a beam from which the crane trolley of the crane trolley assembly as defined above is suspended.

The crane may comprise at least two crane trolleys suspended from the same beam or a parallel beam.

The second crane trolley, and any additional crane trolleys, preferably comprises the same components as the first crane trolley.

It is further described an automated storage and retrieval system comprising a two-dimensional rail system comprising a first set of parallel rails in a horizontal plane arranged to guide movement of container handling vehicles in a first direction across the top of a first frame structure formed by a plurality of upright members, and a second set of parallel rails in the horizontal plane arranged perpendicular to the first set of parallel rails to guide movement of the container handling vehicles in a second direction which is perpendicular to the first direction, the first frame structure defining a plurality of storage columns for accommodating vertical stacks of storage containers and the crane as defined above.

According to one aspect:
the first vertical movement range of the lifting frame may be represented by a first distance between the crane trolley and the rail system; and
the second vertical movement range of the lifting frame may be represented by a second distance between the rail system and a base of the first frame structure.

Alternatively, according to another aspect:
the first vertical movement range of the lifting frame may be represented by a first distance between the crane trolley and a first position represented by one storage container height below the rail system; and
the second vertical movement range of the lifting frame may be represented by a second distance below the first position and a base of the first frame structure. As such, the stabilizer may put and retrieve bins in the uppermost part of the stacks of storage containers, such as e.g. so-called top bins and bins directly below the rail system.

The lifting frame may be guided against the upright members in its corners when in the second vertical movement range.

The crane may span over at least a part of the first frame structure and at least a part of a second frame structure. Thus, the crane trolley may be capable of transferring storage containers between separate frame structures of the automated storage and retrieval system.

The second frame structure may be oriented perpendicular to the first frame structure, and the crane may comprise a crane trolley and a stabilizer, wherein a lower end of the stabilizer may comprise a rotation device for rotating the lower end of the stabilizer relative the stabilizer such that the crane trolley can transfer a storage container between the first frame structure and the second frame structure. Orienting the second frame structure perpendicular to the first frame structure may be advantageous if location or arrangement of e.g. the access stations are most efficient or convenient to orient in a different direction than the orientation of the rail system.

In one aspect, the automated storage and retrieval system may comprise:
a first type of container handling vehicle operating on the rail system, the first type of container handling vehicle comprising a first set of wheels for movement on the rail system in the first direction and a second set of wheels for movement on the rail system in the second direction, and a container carrier for supporting a storage container, the container carrier may be configured to receive a storage container from above;

wherein the lifting frame may be configured to be at a level above an uppermost part of a storage container carried by the container carrier of the first type of container handling vehicle when at least in an upper part of the first vertical movement range, such that the lifting frame can transfer a storage container between the container carrier and the column.

The column can be a storage column or a port column.

The automated storage and retrieval system may comprise a second type of container handling vehicle operating on the rail system, wherein the second type of container handling vehicle may comprise a first set of wheels for movement on the rail system in the first direction and a second set of wheels for movement on the rail system in the second direction, and a first lifting device comprising a first lifting frame suspended from lifting members, wherein the first lifting frame may be raisable at a level above an uppermost part of a storage container carried by the container carrier of the first type of container handling vehicle and is configured to transfer a storage container stored in a stack of storage containers to the container carrier of the first type of container handling vehicle.

It is further described a method of transferring a storage container between a container carrier of a first type of container handling vehicle and a column of the automated storage and retrieval system as defined above using the crane, wherein the method may comprise the steps of:
aligning the first type of container handling vehicle with a storage container arranged on the container carrier directly below the lifting frame of the crane;
lowering the lifting frame under guidance from the stabilizer in a downwards direction into contact with the storage container carried by the container carrier;
connecting the storage container to the lifting frame and lifting the storage container off the container carrier;
moving the first type of container handling vehicle to another location on the rail system;
lowering the lifting frame and thus the connected storage container into an access opening at a top of the column; and
lowering the lifting frame and the connected storage container by spooling out lifting members while the lifting frame is in the second vertical movement range guided by the upright members of the frame structure.

In order to transfer a storage container from a column to a container carrier of a first type of container handling vehicle, the method steps may be performed in reverse order.

The trolley may be stationary above one column all the time and the first type of container handling vehicle is positioned on top of the column directly below the lifting frame such that the lifting frame of the gantry arrangement can lift the storage container off the container carrier of the first type of container handling vehicle. Once the storage container has been lifted, the first type of container handling vehicle may move to another location and the stabilizer of the gantry arrangement can guide the lifting frame and the connected storage container down into an access opening at a top of the column.

It is further described a method of transferring a storage container between a first frame structure having a first orientation and a second frame structure having a second orientation different from the first orientation using a crane which spans over at least a part of the first frame structure and at least a part of the second frame structure, wherein the crane comprises a crane trolley assembly as defined above where the lower end of the stabilizer of the crane trolley assembly is rotatably connected to the stabilizer, wherein the method comprises the steps of:
picking up a storage container from a first type of container handling vehicle or a position within the first frame structure using the lifting frame suspended from the crane trolley;
moving the crane trolley to a position directly above a column of the second frame structure;
rotating the lower end of the stabilizer;
lowering the lifting frame and thus the connected storage container into the column.

The first frame structure may define a two-dimensional rail system arranged across upright members of the first frame structure, the two-dimensional rail system comprising:
a first set of parallel rails in a horizontal plane arranged to guide movement of container handling vehicles in a first direction, and
a second set of parallel rails in the horizontal plane arranged perpendicular to the first set of parallel rails to guide movement of the container handling vehicles in a second direction which is perpendicular to the first direction.

It is further described an automated storage and retrieval system comprising a frame structure, the frame structure comprises upright members, a storage volume comprising storage columns arranged in rows between the upright members for accommodating vertical stacks of storage containers, and a two-dimensional rail system arranged across the top of the frame structure, the rail system comprising a first set of parallel rails in a horizontal plane arranged to guide movement of container handling vehicles in a first direction across the top of the frame structure, and a second set of parallel rails in the horizontal plane arranged perpendicular to the first set of parallel rails to guide movement of the container handling vehicles in a second direction which is perpendicular to the first direction, wherein the automated storage and retrieval system comprises:
a crane above the rail system, the crane comprising:
   a crane trolley assembly comprising a movable stabilizer and a lifting device, wherein the lifting device comprises:
      at least one lifting shaft and a plurality of lifting members spoolable onto and off the at least one lifting shaft;
      oa lifting frame suspended by the lifting members; and wherein the stabilizer is configured for guiding the lifting frame when the lifting frame is above the rail system, and wherein a lower end of the stabilizer is movable between an upper position and a lower position such that:
      in the upper position the lower end of the stabilizer, the lifting frame is arranged at a distance above the rail system; and
      in the lower position of the lower end of the stabilizer, the lifting frame is arranged at or below the rail system.

In other words, the stabilizer is arranged to be movable in a downwards direction to guide movement of the lifting frame into an access opening in the underlying rail system. The stabilizer is configured to minimize movement of the lifting frame in a horizontal plane during movement of the stabilizer between the upper position and the lower position.

The upright members are configured for guiding the lifting frame when the lifting frame is within the frame structure, i.e. below the rail system.

The automated storage and retrieval system may comprise a plurality of upright members and each storage column is defined by four of the upright members.

The rail system may be arranged on top of the upright members, the rail system comprising a first set of parallel rails and a second set of parallel rails arranged perpendicular to the first set of rails. The first and second set of rails providing a horizontal grid-based rail system defining a plurality of grid cells.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the automated storage and retrieval system and the goods to be stored. The gripping recesses may be arranged at an upper rim of the sidewalls. The outer horizontal periphery of the storage container is preferably rectangular.

The relative terms “upper”, “lower”, “below”, “above”, “higher” etc. shall be understood in their normal sense and as seen in a cartesian coordinate system.

The invention may be used in connection with storage containers and systems as described above. However, other areas where the disclosed automated storage and retrieval system and methods may be used is within vertical farming, micro-fulfilment or grocery/e-grocery.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a frame structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a perspective view of the container handling vehicle in FIG. 4 without side and top panels;

FIGS. 6A-6D are different views of a crane trolley assembly according to a first embodiment with lifting members extending to the crane trolley, where FIG. 6A is a perspective view where the lifting frame is within a first vertical movement range, FIG. 6B is a side view of FIG. 6A, FIG. 6C is another side view perpendicular to FIG. 6B, and FIG. 6D is a perspective view where the lifting frame is within a second vertical movement range;

FIG. 7A is a side perspective view of an automated storage and retrieval system with a rail system and one crane above the rail system, the crane is arranged at a port area of the rail system and comprises a first beam and a second beam, and crane trolley assemblies of FIGS. 6A-6D according to the first embodiment are suspended from the first and second beams;

FIG. 7B is a perspective view of an automated storage and retrieval system with a rail system and three cranes above the rail system, the cranes are arranged at a port area of the rail system and comprises a first beam and a second beam, and the crane trolley assemblies according to the first embodiment are suspended from the first and second beams;

FIGS. 7C and 7D are perspective views of the automated storage and retrieval system of FIG. 7A from different angles;

FIGS. 7E and 7F are different side views of the automated storage and retrieval system of FIG. 7A;

FIG. 7G is a top view of the automated storage and retrieval system of FIG. 7A;

FIG. 7H is a perspective view of a first or second beam of a crane with three crane trolley assemblies according to the first embodiment suspended from the beam;

FIG. 7I is a perspective view from below of the beam and crane trolley assemblies in FIG. 7H;

FIG. 7J is a detailed view of the first or second beam in FIGS. 7H and 7I;

FIG. 7K is a perspective view from below of the crane in FIG. 7A;

FIG. 7L is a side perspective view of an automated storage and retrieval system with a rail system and one crane above the rail system and partly outside of the rail system, the crane is arranged at a port area of the rail system and comprises a first beam and a second beam, and the crane trolley assemblies according to the first embodiment are suspended from the first and second beams;

FIGS. 8A-8C are different views of a crane trolley assembly according to a second embodiment with lifting members extending to a lower end of a stabilizer of the crane trolley assembly, where FIG. 8A is a perspective view where the lifting frame is within a second vertical movement range, FIG. 8B is a side view of FIG. 8A from a first angle and FIG. 8C is a side view of FIG. 8A from a second angle;

FIG. 9A is a side perspective view of an automated storage and retrieval system with a rail system and one crane above the rail system and partly outside of the rail system, the crane is arranged at a port area of the rail system and comprises a first beam and a second beam, and the crane trolley assemblies according to the second embodiment are suspended from the first and second beams;

FIG. 9B is another view of the automated storage and retrieval system in FIG. 9A;

FIG. 9C is a side perspective view of the automated storage and retrieval system in FIGS. 9A and 9B, where there are arranged a mezzanine next to the rail system and two access stations on the mezzanine as well as two access stations below the mezzanine, and where the crane extends partly over the rail system and partly over the mezzanine;

FIG. 9D is a side view of FIG. 9C;

FIG. 9E is a side perspective view from below of the crane in FIGS. 9A-9D with crane trolley assemblies according to the second embodiment suspended from the crane;

FIG. 9F is a perspective view of a first or second beam of a crane with four crane trolley assemblies according to the second embodiment suspended from the beam;

FIG. 9G is a perspective view from below of the first or second beam in FIG. 9F;

FIG. 9H is a detailed view of the first or second beam in FIGS. 9F and 9G;

FIG. 10 is a perspective view of a crane trolley assembly according to a third embodiment with lifting members extending to a lower end of a stabilizer of the crane trolley assembly, and where the lower end of the stabilizer can rotate relative the stabilizer;

FIGS. 11A and 11B are different views of an automated storage and retrieval system comprising a first frame structure having a first orientation and a second frame structure having a second orientation different from the first orientation, and a crane spanning over the first and second frame structures with crane trolley assemblies according to the third embodiment suspended from the crane;

FIG. 11C is a top view of the automated storage and retrieval system in FIGS. 11A and 11B;

FIG. 11D is a perspective view of a first or second beam with six crane trolley assemblies according to the third embodiment suspended from the beam;

FIG. 12 is a side perspective view of an example first type of container handling vehicle;

FIG. 13 is and example multi-cantilever container handling vehicle which can operate on the rail system together with the cranes;

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

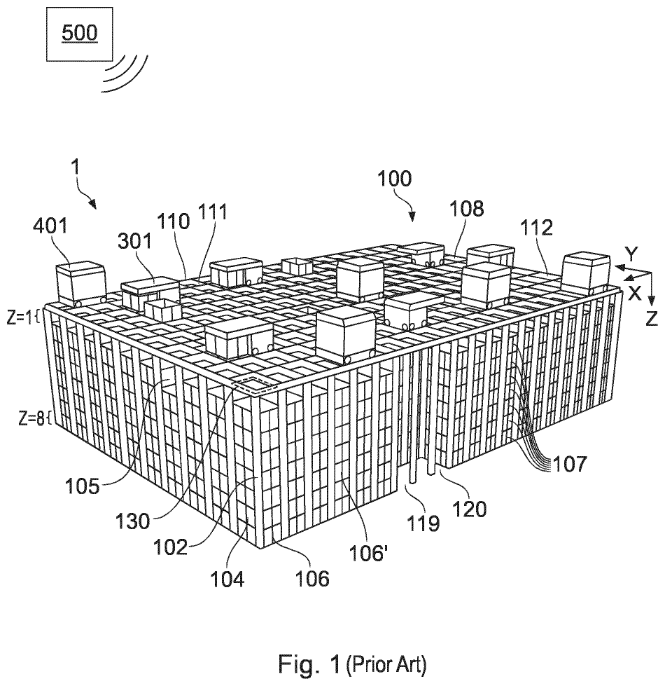

A frame structure 100 of the automated storage and retrieval system 1 may be constructed in a similar manner to the prior art frame structure 100 described above in connection with FIG. 1. That is, the frame structure 100 may comprise a number of upright members 102, and comprise a first, upper rail system 108 extending in the X direction and Y direction.

The frame structure 100 may comprise storage compartments in the form of storage columns 105 provided between the members 102 wherein storage containers 106 may be stackable in stacks 107 within the storage columns 105.

The frame structure 100 can be of any size. In particular, it is understood that the frame structure can be considerably wider and/or longer and/or deeper than disclosed in FIG. 1. For example, the frame structure 100 may have a horizontal extent of more than 700×700 columns and a storage depth of more than twelve containers.

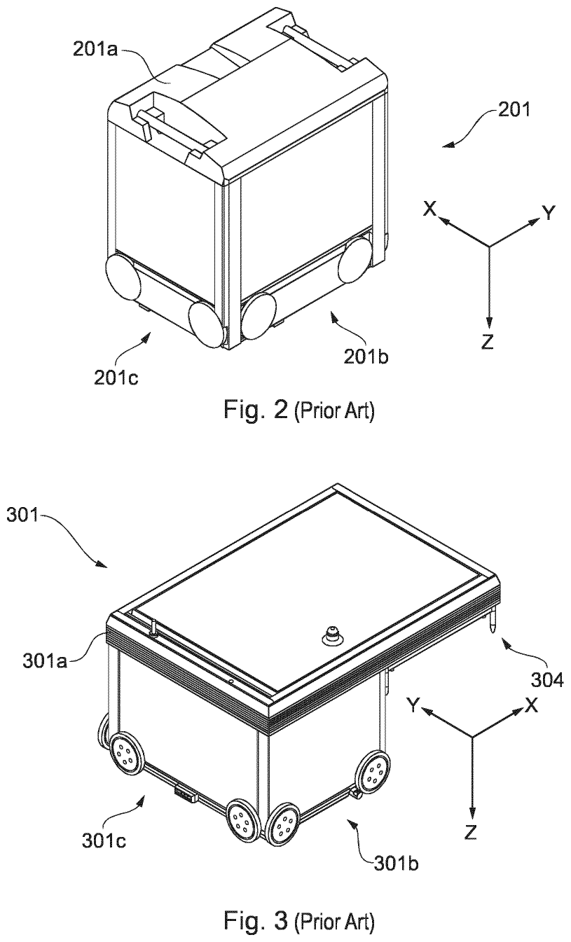

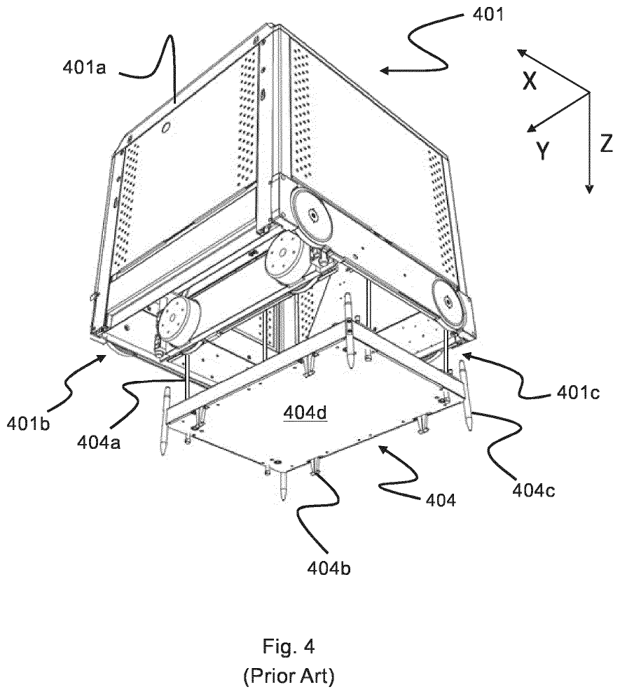

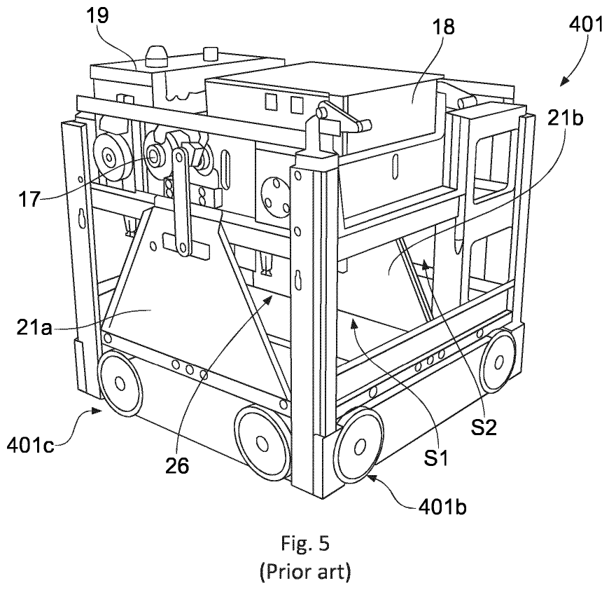

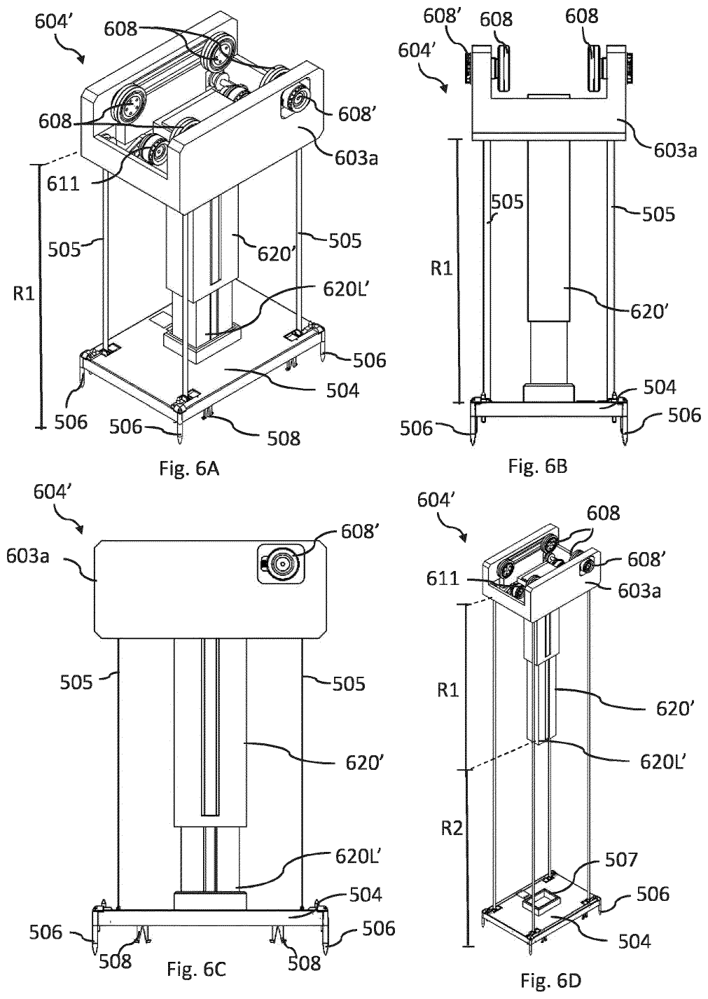

The prior art container handling vehicles comprising a cavity for accommodating a storage container, see FIGS. 2, 4 and 5, have certain advantageous features. In particular, the guidance/support provided to a storage container when accommodated in the cavity entails that the vehicles may have increased acceleration/retardation relative to the cantilevered container handling vehicle 301 shown in FIG. 3. However, the potential increase in acceleration/retardation is not fully realized due to instability of the vehicles. The instability is caused by both vehicles 201,401 having most of the drive, power, control and lifting components arranged above the cavity, providing a high centre of gravity.

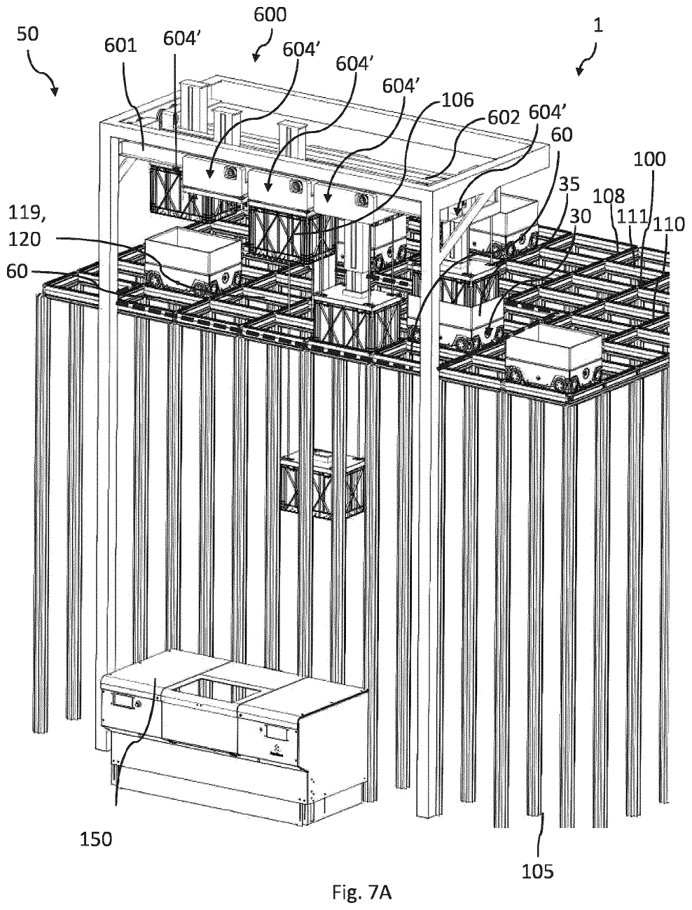

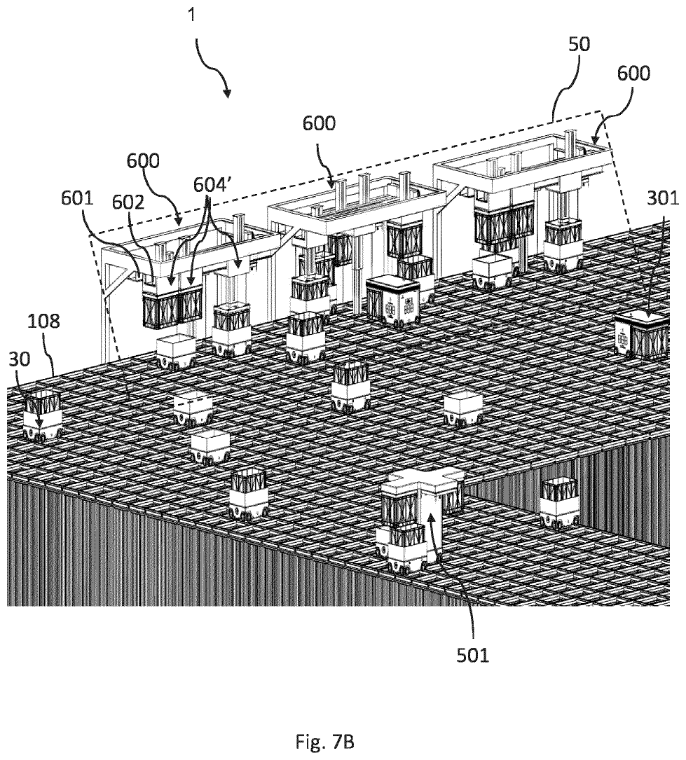

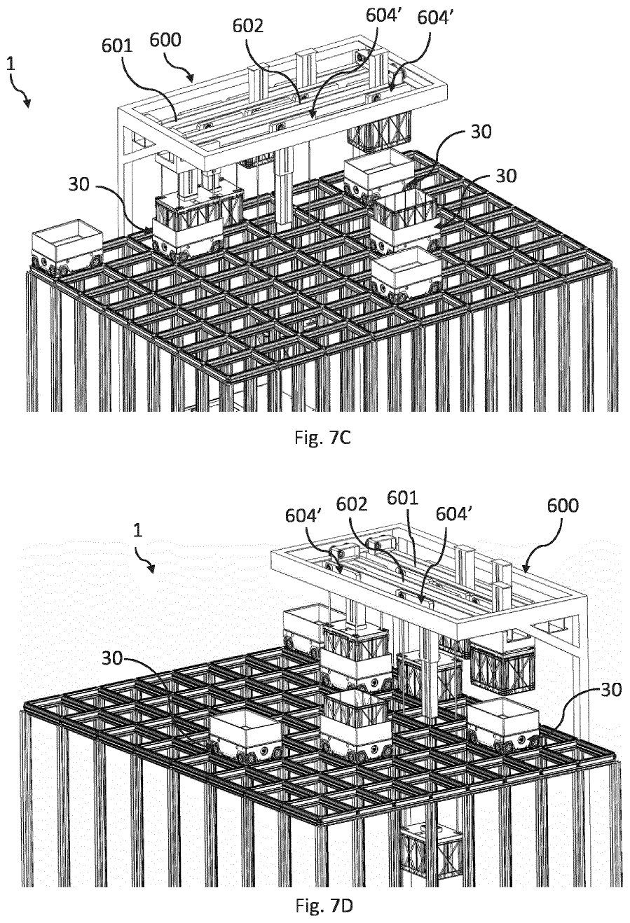

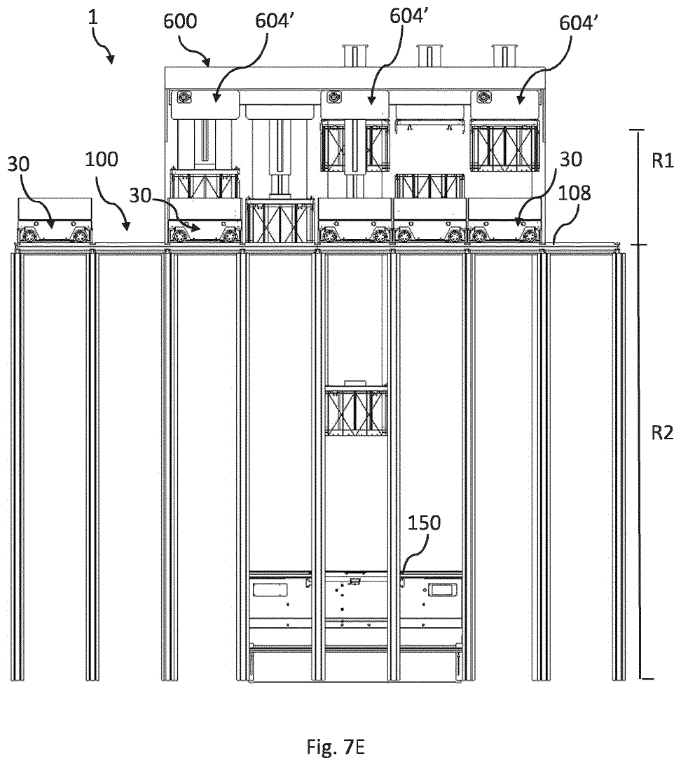

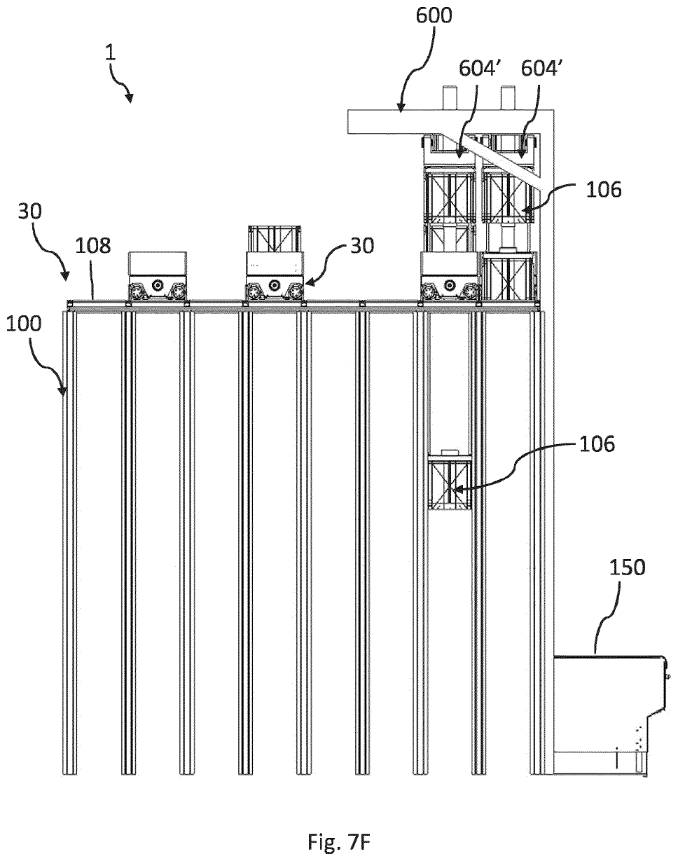

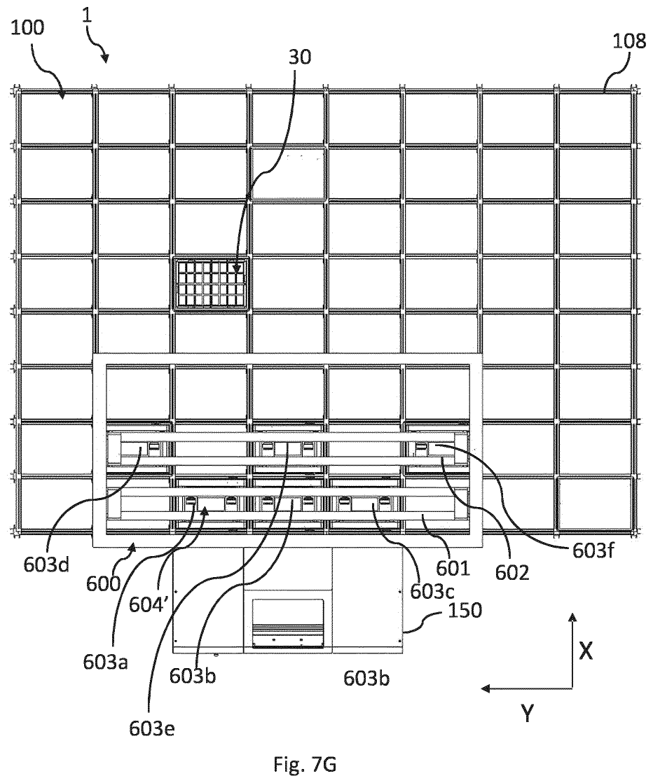

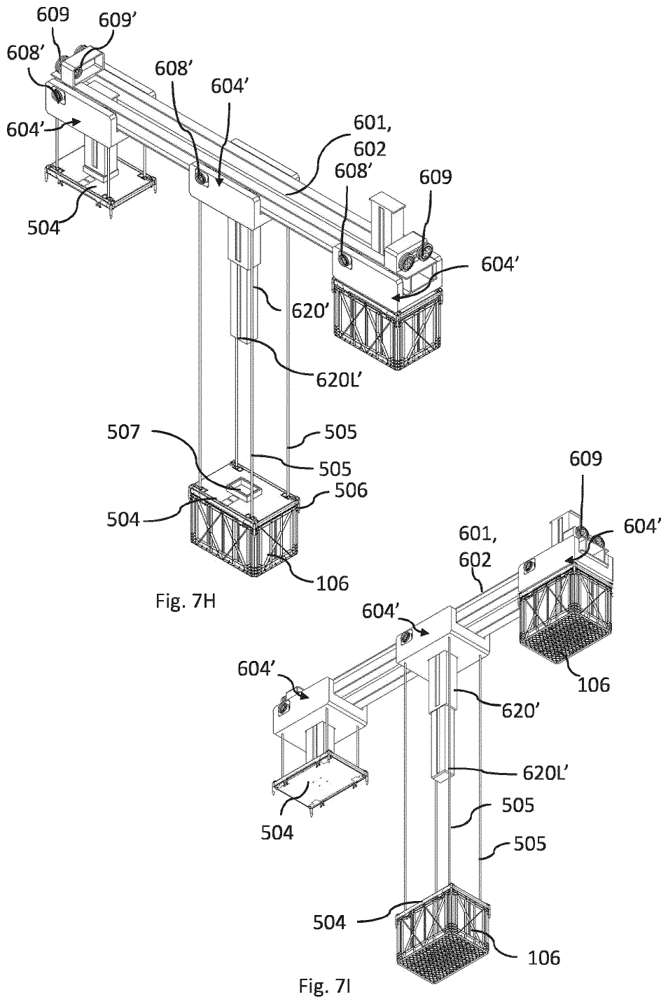

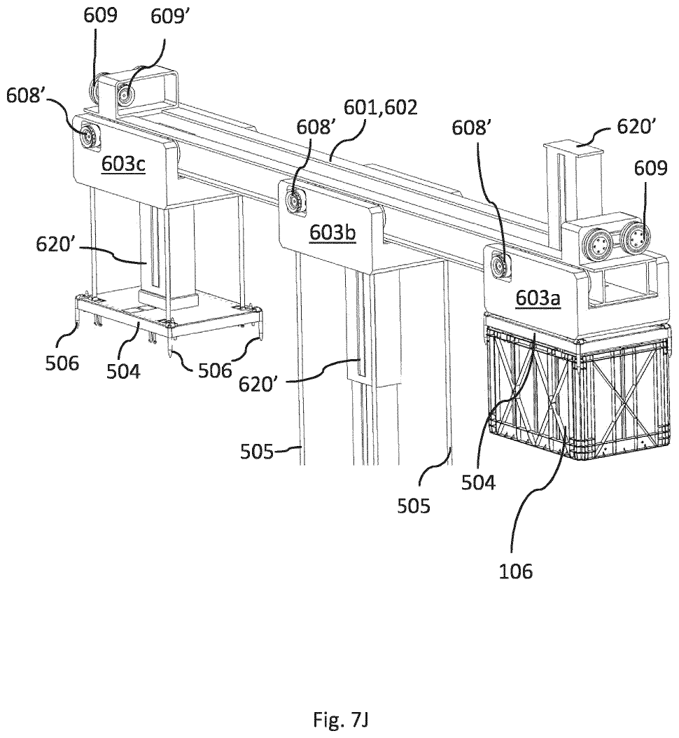

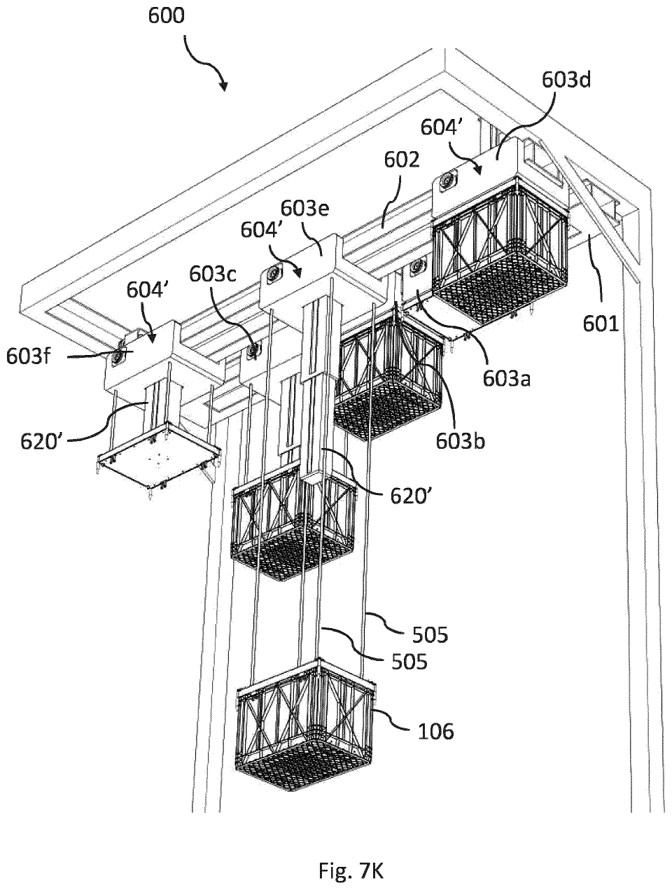

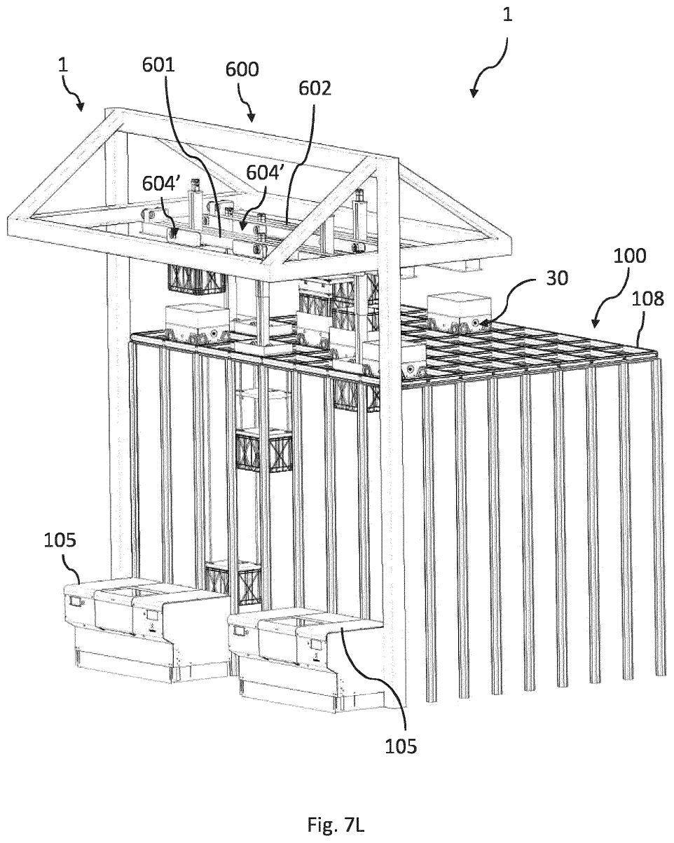

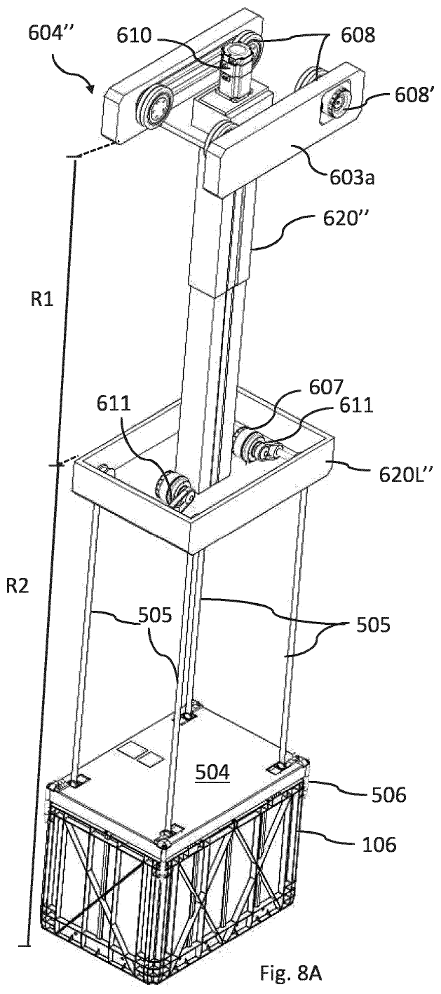

### First Embodiment of Crane Trolley Assembly, FIGS. 6 and 7

FIGS. 6A-6D are different views of a crane trolley assembly 604′ according to a first embodiment with lifting members 505 extending to the crane trolley 603a. FIG. 6A is a perspective view where the lifting frame 504 is within a first vertical movement range R1. FIG. 6B is a side view of FIG. 6A, FIG. 6C is another side view perpendicular to FIG. 6B, and FIG. 6D is a perspective view where the lifting frame 504 is within a second vertical movement range R2.

Referring to FIGS. 6A-6D, details of crane trolley assembly 604′ according to the first embodiment will be described in greater detail. The crane trolley 603a is configured for guided movement along a beam 601,602 (not shown in FIGS. 6A-6D, see for example FIG. 7A) of a crane 600 (not shown in FIGS. 6A-6D, see for example FIG. 7A) and features a lifting frame 504 configured for connection to a storage container 106 (storage container not shown in FIGS. 6A-6D, see for example FIG. 7A) to lift the storage container 106 from above through the first vertical movement range R1 and the second vertical movement range R2 of the lifting frame 504.

The crane trolley assembly 604′ features a plurality of lifting members 505 suspending the lifting frame 504 below the crane trolley 603a for lifting and lowering the lifting frame 504 through at least the second vertical movement range R2 and a stabilizer 620′ extending below the crane trolley 603a. A lower end 620L′ of the stabilizer 620′ is configured to interact with the lifting frame 504 in order to stabilize the lifting frame 504 during the first vertical movement range R1 of the lifting frame 504. The stabilizer 620′ and the lifting frame 504 are configured to move vertically relative each other when in the second vertical movement range R2 of the lifting frame 504. The distance between the stabilizer 620′ and the lifting frame 504 increases when the lifting frame 504 continues to move vertically below a reach of the lower end 620L′ of the stabilizer 620′.

The stabilizer 620′ is configured to stabilize the lifting and lowering of the lifting frame 504 by guiding movement of the lifting frame 504 in a vertical direction below the crane trolley 603a while restricting horizontal movement of the lifting frame 504 during the first vertical movement range R1 of the lifting frame 504 when the lower end 620L′ of the stabilizer 620′ interacts with lifting frame 504. The lifting frame 504 is provided with a socket 507 to locate the lower end 620L′ of the stabilizer 620′, whereby sides of the socket 507 engaging with the lower end 620L′ of the stabilizer restrict horizontal movement of the lifting frame 504 during the first vertical movement range R1.

Dependent on the use of the crane trolley assembly, the stabilizer 620′ may have a maximum reach which is shorter than the maximum reach of the lifting members 505.

The first and second vertical movement ranges R1,R2 are subsequent movement ranges, i.e. the second vertical movement range R2 succeeds the first vertical movement range R1, and vice versa. In other words, the first and second vertical movement range R1,R2 do not overlap each other. The first vertical movement range is closer to the crane trolley relative the second vertical movement range R2.

The lifting frame 504 is preferably rectangular and comprises guides 506 at its corners for guiding the lifting frame 504 within storage columns 105 (not shown in FIGS. 6A-6D, but see e.g. FIG. 7A) of a frame structure 100 (not shown in FIGS. 6A-6D, but see e.g. FIG. 7A) of an automated storage and retrieval system 1 during the second vertical movement range R2. The guides 506 assist in aligning the grippers 508 relative the gripping recesses of the storage container 106.

The crane trolley 603a is disclosed with a first lateral movement arrangement 608 for movement along the first beam 601 and/or the second beam 602. The lateral movement arrangement 608 is shown as being in the form of wheels 608 which are driven by a first wheel motor 608′. The crane trolley 603a is thus be movable in a horizontal plane along the first beam 601 and/or the second beam 602.

The stabilizer 620′ comprises an extendable mechanism for moving the lower end 620L′ relative the crane trolley 603a. The extendable mechanism of the stabilizer 620′ in FIGS. 6A-6D is shown as a telescopic mechanism. The stabilizer 620′ is arranged between the lifting members 505.

The plurality of lifting members 505 are arranged to wind onto and off spools 611. The spools 611 are positioned at the crane trolley 603a.

FIG. 7A is a side perspective view of an automated storage and retrieval system 1 with a rail system 108 and one crane 600 above the rail system 108. The crane 600 is arranged at a port area 50 of the rail system 108 and comprises a first beam 601 and a second beam 602. Crane trolley assemblies 604′ of FIGS. 6A-6D according to the first embodiment are suspended from the first and second beams 601,602. The first and second beams extend in the same direction as the second set of parallel rails 111 of the rail system 108.

An access station 150 is arranged at floor level below the crane 600 such that the crane trolley assemblies 604′ can deliver storage containers to the access station 150. A number of first type of container handling vehicle 30 in the form of delivery vehicles 30 with a container carrier 35 for supporting a storage container 106 operate on the rail system 108. The container carrier 35 is configured to receive a storage container 106 from above. The delivery vehicles 30 can position themselves directly below a lifting frame 504 such that a storage container 106 can be lifted from the container carrier 35 or placed onto the container carrier 35 by the lifting frame 504 of the crane trolley assembly 604.

The port (i.e. the access station 150) can be arranged at a lower part of the port column 119,120 and the lifting frame 504 of the crane trolley assembly 604 can be raised and lowered between a docked position at the crane trolley 603a and the port. The crane 600 or gantry arrangement 600 is raisable at a level above an uppermost part of a storage container 106 carried by the container carrier 35 of the first type of container handling vehicle 30 and is configured to transfer a storage container (106) between the container carrier 35 and the port column 119,120.

The crane 600 is arranged in a fixed position within the port area 50 and at a fixed position above the port columns 119,120.

FIG. 7B is a perspective view of an automated storage and retrieval system 1 with a rail system 108 and three cranes 600 above the rail system 108. The cranes 600 are arranged at a port area 50 of the rail system 108 and comprises a first beam 601 and a second beam 602. Crane trolley assemblies 604′ according to the first embodiment are suspended from the first and second beams 601,602.

A number of the first type of container handling vehicles 30 as well as cantilever container handling vehicles 501 operate on the rail system.

FIGS. 7C and 7D are perspective views of the automated storage and retrieval system 1 of FIG. 7A from different angles.

FIGS. 7E and 7F are different side views of the automated storage and retrieval system 1 of FIG. 7A.

FIG. 7G is a top view of the automated storage and retrieval system 1 of FIG. 7A.

FIG. 7H is a perspective view of a first or second beam 601,602 of a crane 600 with three crane trolley assemblies 604′ according to the first embodiment suspended from the beam 601,602. The beam 601,602 features a second lateral movement arrangement 609 for moving the beam in a perpendicular direction relative the first lateral movement arrangement 608 (see e.g. FIGS. 6A,6B,6D). The second lateral movement arrangement 609 is shown as being in the form of wheels 609 which are driven by a second wheel motor 609′.

FIG. 7I is a perspective view from below of the beam 601,602 and crane trolley assemblies 604′ in FIG. 7H.

FIG. 7J is a detailed view of the first or second beam 601,602 in FIGS. 7H and 7I.

FIG. 7K is a perspective view from below of the crane 600 in FIG. 7A.

FIG. 7L is a side perspective view of an automated storage and retrieval system 1 with a rail system 108 and one crane 600 above the rail system 108 and partly outside of the rail system 108. The crane 600 is arranged at a port area 50 of the rail system 108 and comprises a first beam 601 and a second beam 62, and the crane trolley assemblies 604′ according to the first embodiment are suspended from the first and second beams 601,602.

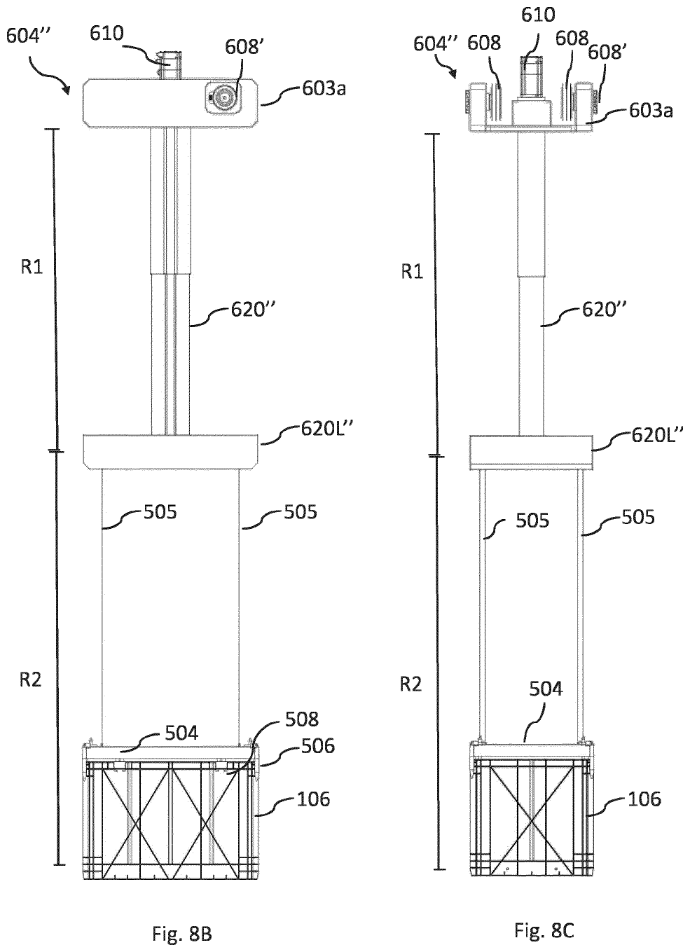

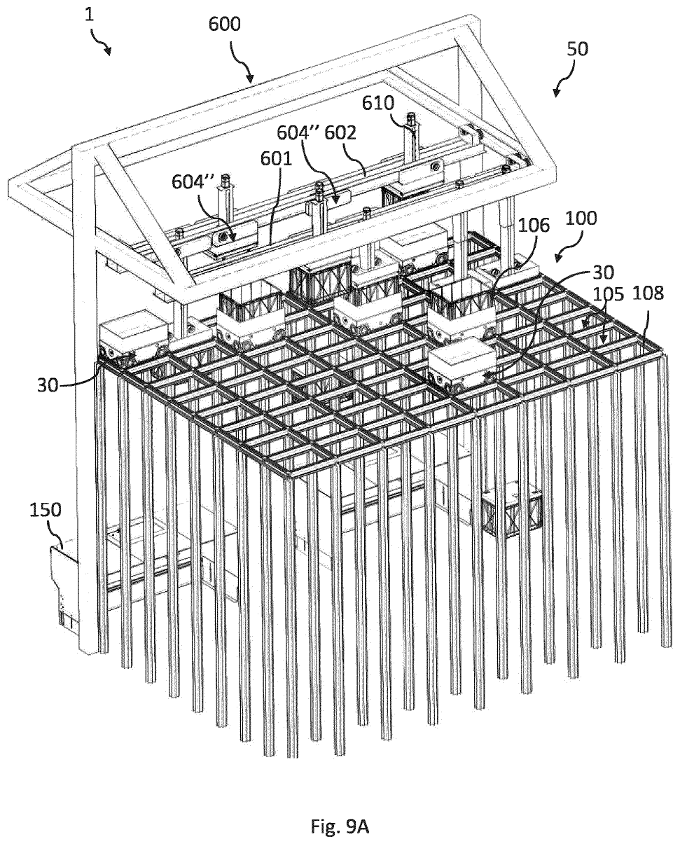

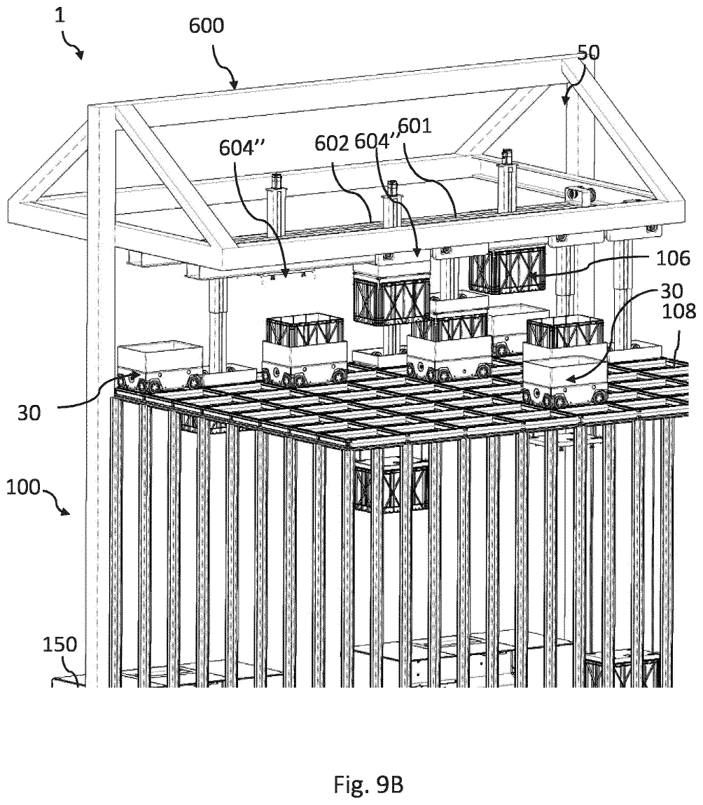

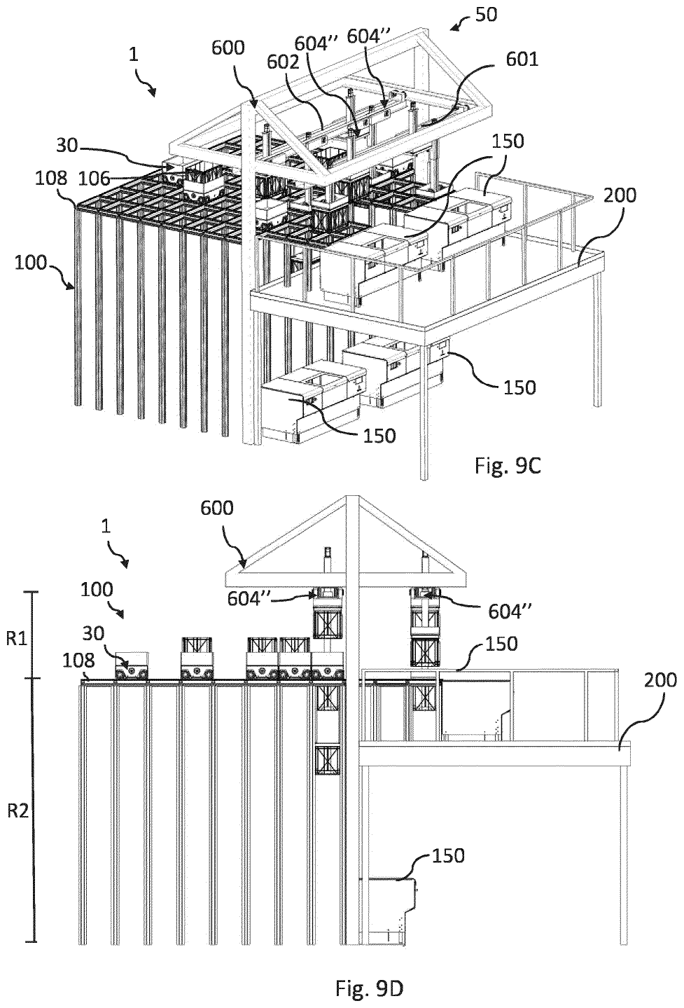

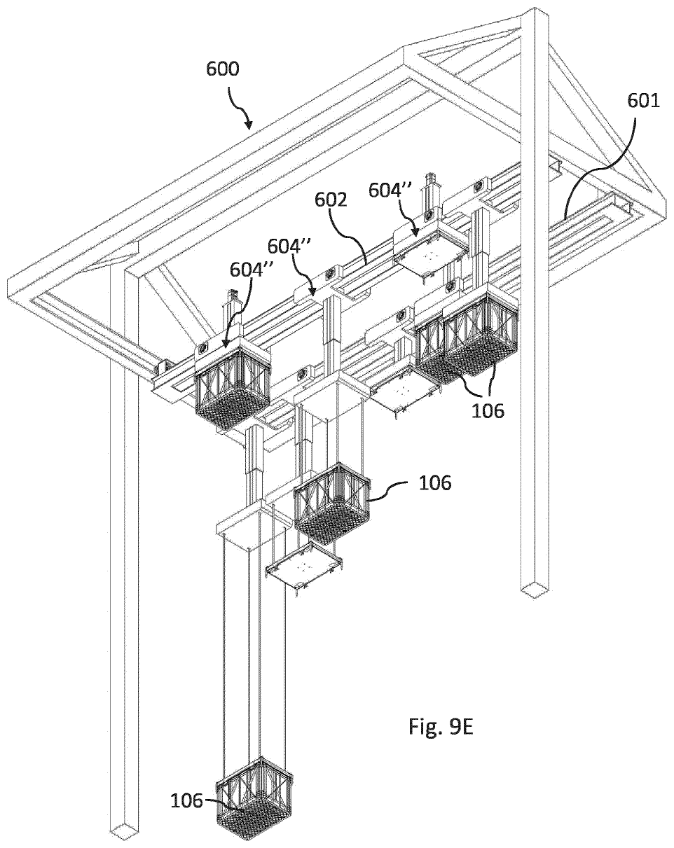

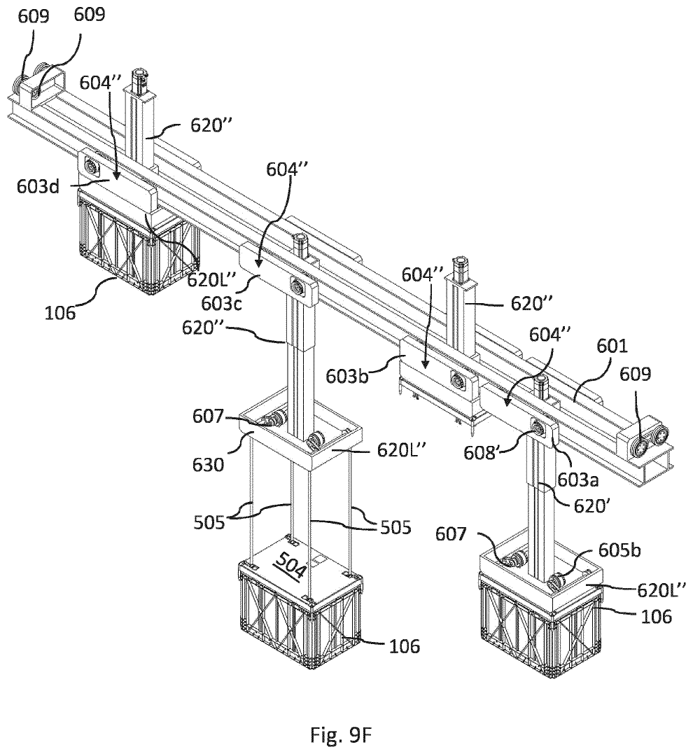

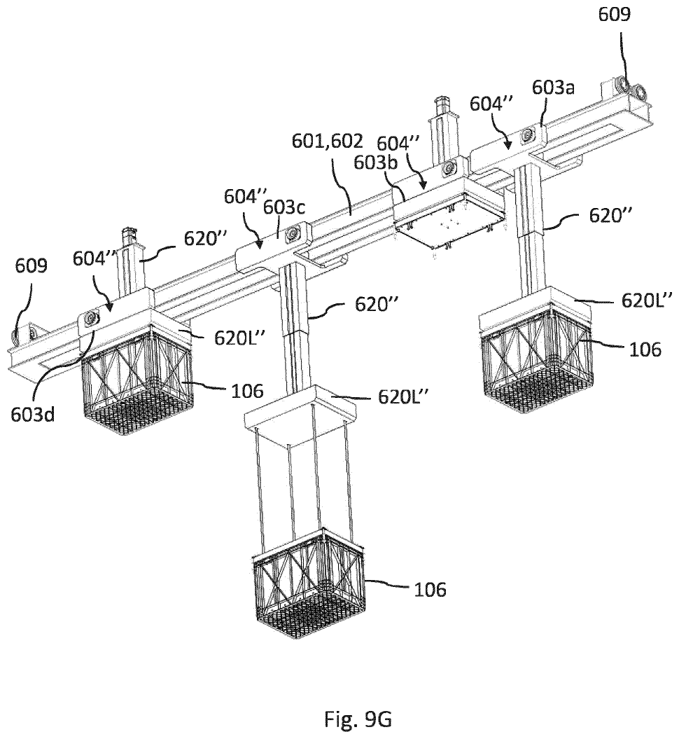

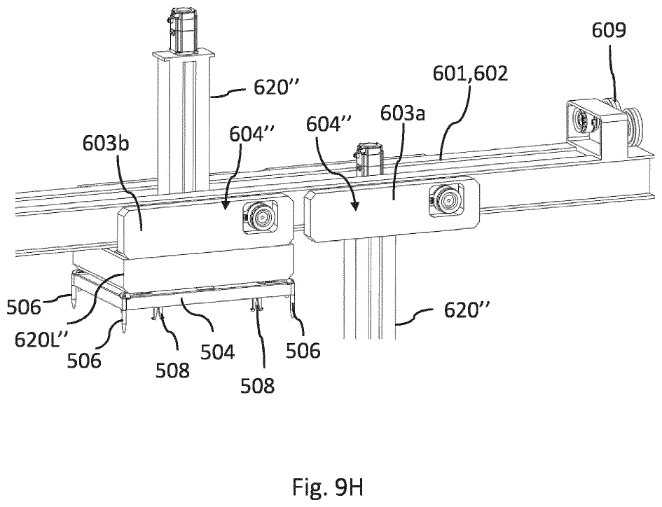

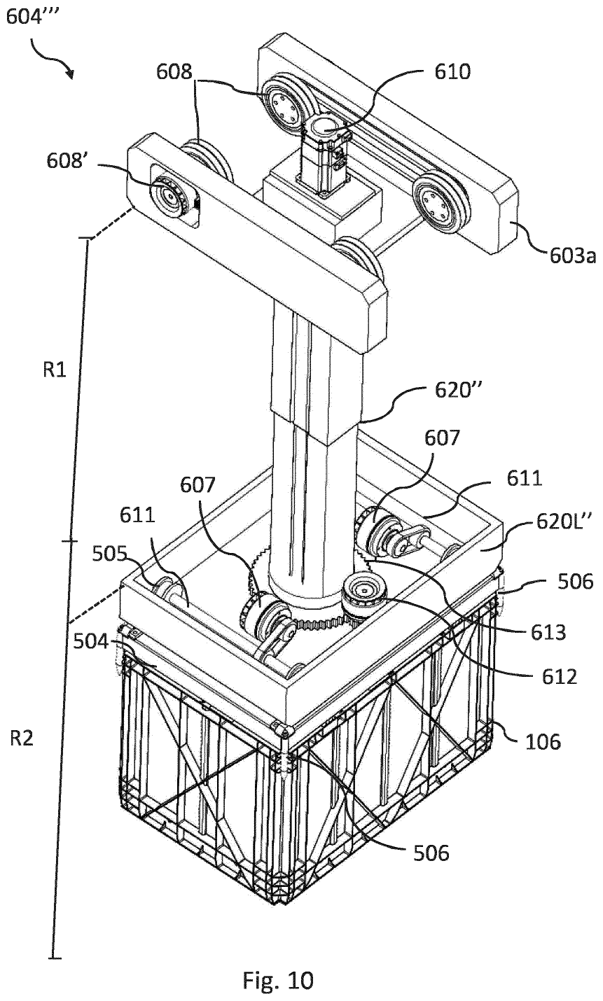

Second embodiment of crane trolley assembly. FIGS. 8 and 9

Referring to FIGS. 8A-8C different views of a crane trolley assembly 604″ according to a second embodiment with lifting members 505 extending to a lower end 620L″ of a stabilizer 620″ of the crane trolley assembly 604″. FIG. 8A is a perspective view where the lifting frame 504 is within a second vertical movement range, FIG. 8B is a side view of FIG. 8A from a first angle and FIG. 8C is a side view of FIG. 8A from a second angle.

The crane trolley 603a is configured for guided movement along a beam 601,602 (not shown in FIGS. 8A-8C, see for example FIG. 9A) of a crane 600 (not shown in FIGS. 8A-8C, see for example FIG. 9A) and features a lifting frame 504 configured for connection to a storage container 106 (storage container not shown in FIGS. 8A-8C, see for example FIG. 9A) to lift the storage container 106 from above through the first vertical movement range R1 and the second vertical movement range R2 of the lifting frame 504.

The crane trolley assembly 604″ features a plurality of lifting members 505 suspending the lifting frame 504 below the crane trolley 603a for lifting and lowering the lifting frame 504 through at least the second vertical movement range R2 and a stabilizer 620″ extending below the crane trolley 603a.

The stabilizer 620″ as shown is a telescopic mechanism where the stabilizer 620″ is formed of sections which can collapse into each other upon retraction of the stabilizer 620″. The stabilizer 620″ is actively moving the lower end 620″ of the stabilizer relative the crane trolley 603a. The stabilizer 620″ may be driven up and down by a stabilizer motor 610 arranged at the crane trolley 603a. Independent drive of the stabilizer 620″ provides for the possibility of increased acceleration of the lower end of the stabilizer, and thus the lifting frame, compared to the acceleration caused by gravity alone.

A lower end 620L″ of the stabilizer 620′ is configured to interact with the lifting frame 504 in order to stabilize the lifting frame 504 during the first vertical movement range R1 of the lifting frame 504. The stabilizer 620″ and the lifting frame 504 are configured to move vertically relative each other when in the second vertical movement range R2 of the lifting frame 504. The distance between the stabilizer 620″ and the lifting frame 504 increases when the lifting frame 504 continues to move vertically below a reach of the lower end 620L″ of the stabilizer 620″.

The stabilizer 620″ is configured to stabilize the lifting and lowering of the lifting frame 504 by guiding movement of the lifting frame 504 in a vertical direction below the crane trolley 603a while restricting horizontal movement of the lifting frame 504 during the first vertical movement range R1 of the lifting frame 504 when the lower end 620L″ of the stabilizer 620″ interacts with lifting frame 504. The lower end 620L″ of the stabilizer 620″ is fixedly connected to the stabilizer 620″, i.e. the lower end 620L″ of the stabilizer 620″ moves together with the stabilizer 620″.

Dependent on the use of the crane trolley assembly, the stabilizer 620″ may have a maximum reach which is shorter than the maximum reach of the lifting members 505.

The first and second vertical movement ranges R1,R2 are subsequent movement ranges, i.e. the second vertical movement range R2 succeeds the first vertical movement range R1, and vice versa. In other words, the first and second vertical movement range R1,R2 do not overlap each other. The first vertical movement range is closer to the crane trolley relative the second vertical movement range R2.

The lifting frame 504 is preferably rectangular and comprises guides 506 at its corners for guiding the lifting frame 504 within storage columns 105 (not shown in FIGS. 8A-8C, but see e.g. FIG. 9A) of a frame structure 100 (not shown in FIGS. 8A-8C, but see e.g. FIG. 9A) of an automated storage and retrieval system 1 during the second vertical movement range R2. The guides 506 assist in aligning the grippers 508 relative the gripping recesses of the storage container 106 (see details of the guides 506 and grippers 508 e.g. in FIG. 9H).

The crane trolley 603a is disclosed with a first lateral movement arrangement 608 for movement along the first beam 601 and/or the second beam 602. The lateral movement arrangement 608 is shown as being in the form of wheels 608 which are driven by a first wheel motor 608′. The crane trolley 603a is thus be movable in a horizontal plane along the first beam 601 and/or the second beam 602.

The stabilizer 620″ comprises an extendable mechanism for moving the lower end 620L″ relative the crane trolley 603a. The extendable mechanism of the stabilizer 620″ in FIGS. 8A-8C is shown as a stabilizer 620″ which can run through the crane trolley 603a.

The plurality of lifting members 505 are arranged to wind onto and off spools 611. The spools 611 are positioned at the lower end 620L″ of the stabilizer 620″. A lifting device motor 607 is also arranged at the lower end 620L″ of the stabilizer 620″.

FIG. 9A is a side perspective view of an automated storage and retrieval system 1 with a rail system 108 and one crane 600 above the rail system 108 and partly outside of the rail system 108, the crane 600 is arranged at a port area 50 of the rail system 108. The crane 600 comprises a first beam 601 and a second beam 602, and the crane trolley assemblies 604″ according to the second embodiment are suspended from the first and second beams 601,602.

FIG. 9B is another view of the automated storage and retrieval system 1 in FIG. 9A.

FIG. 9C is a side perspective view of the automated storage and retrieval system 1 in FIGS. 9A and 9B, where there are arranged a mezzanine 200 next to the rail system 108 and two access stations 150 on of the mezzanine 200 as well as two access stations 150 below the mezzanine 200. The crane 600 extends partly over the rail system 108 and partly over the mezzanine 200.

The port (i.e. the access station 150) can be arranged at a lower part of the port column 119,120 and the lifting frame 504 of the crane trolley assembly 604″ can be raised and lowered between a docked position at the crane trolley 603a and the port.

FIG. 9D is a side view of FIG. 9C.

FIG. 9E is a side perspective view from below of the crane 600 in FIGS. 9A-9D with crane trolley assemblies 604″ according to the second embodiment suspended from the crane 600.

FIG. 9F is a perspective view of a first or second beam 601,602 of a crane 600 with four crane trolley assemblies 604″ according to the second embodiment suspended from the beam 601,602. The beam 601,602 features a second lateral movement arrangement 609 for moving the beam in a perpendicular direction relative the first lateral movement arrangement 608 (see e.g. FIGS. 8A-8C). The second lateral movement arrangement 609 is shown as being in the form of wheels 609 which are driven by a second wheel motor 609′.

FIG. 9G is a perspective view from below of the first or second beam 601,602 in FIG. 9F.

FIG. 9H is a detailed view of the first or second beam in FIGS. 9F and 9G;

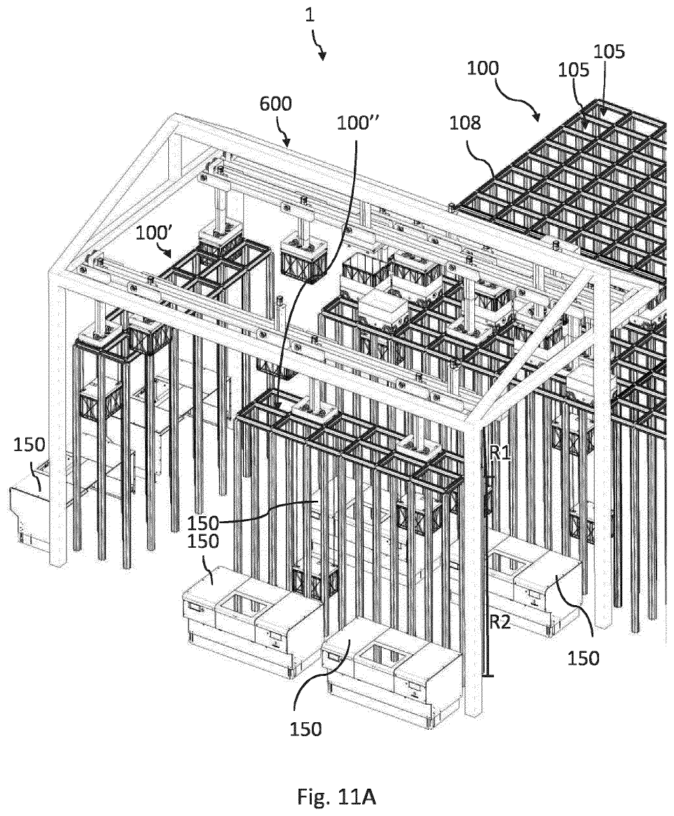

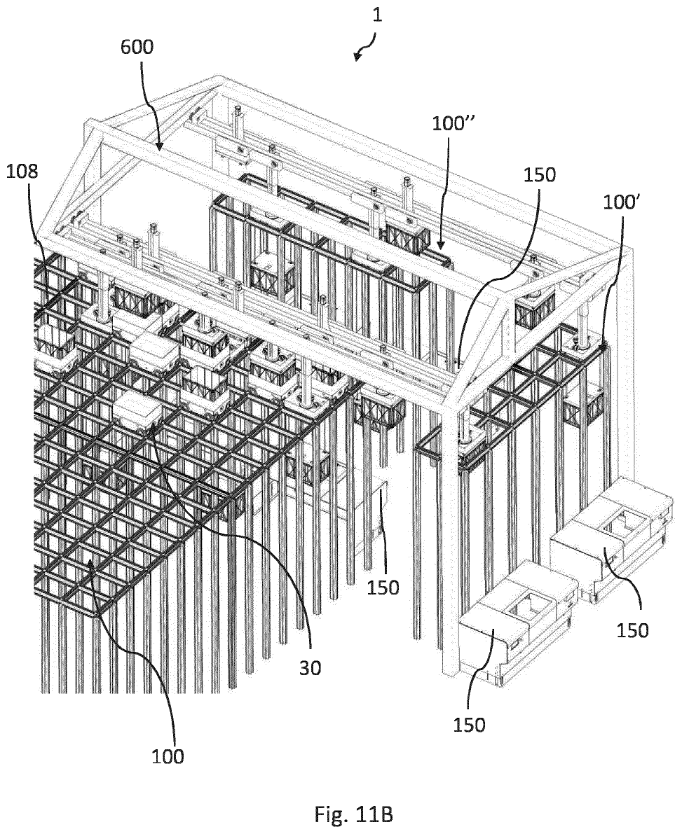

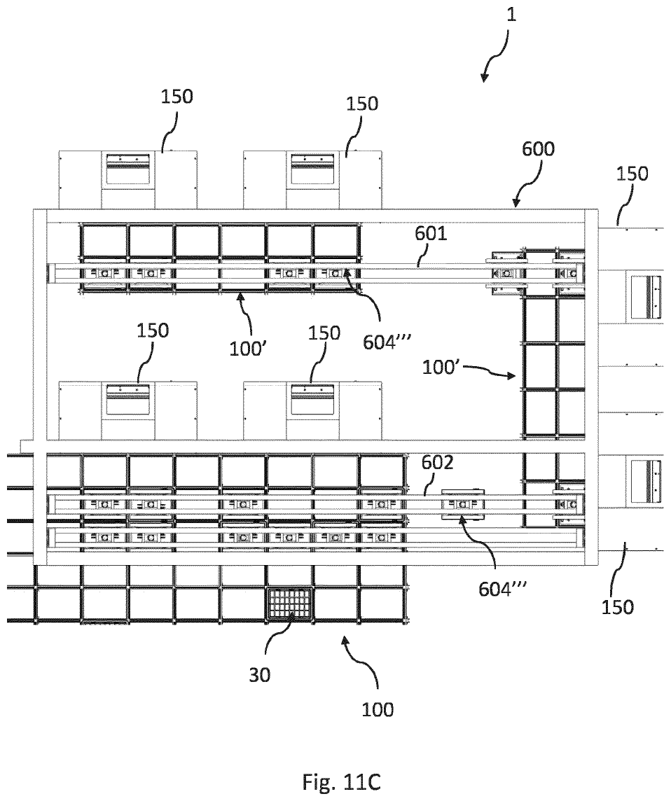

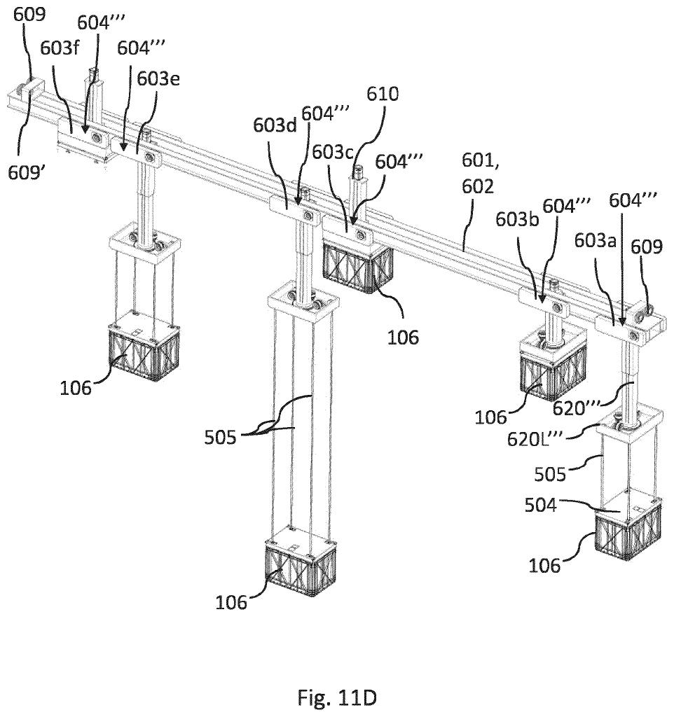

### Third Embodiment of Crane Trolley Assembly, FIGS. 10 and 11

Referring to FIG. 10 it is shown a perspective view of a crane trolley assembly 604″′ according to a third embodiment with lifting members 505 extending to a lower end 620L″′ of a stabilizer 620″′ of the crane trolley assembly 604″′, and where the lower end 620L″′ of the stabilizer 620″′ can rotate relative the stabilizer 620″′. Most of the features of the crane trolley assembly 604″′ in FIG. 10 is similar to the crane trolley assembly 604″ according to the second embodiment shown in FIGS. 8A-8C.

The rotation is performed using a rotation device 612 which is connected to a gear arrangement 613 or similar for rotating the lower end of the stabilizer 620L″′.

The crane trolley 603a is configured for guided movement along a beam 601,602 (not shown in FIG. 10, see for example FIG. 11A) of a crane 600 (not shown in FIG. 10, see for example FIG. 11A) and features a lifting frame 504 configured for connection to a storage container 106 (storage container not shown in FIG. 10, see for example FIG. 11A) to lift the storage container 106 from above through the first vertical movement range R1 and the second vertical movement range R2 of the lifting frame 504.

The crane trolley assembly 604″′ features a plurality of lifting members 505 suspending the lifting frame 504 below the crane trolley 603a for lifting and lowering the lifting frame 504 through at least the second vertical movement range R2 and a stabilizer 620″′ extending below the crane trolley 603a.

The stabilizer 620″′ as shown is a telescopic mechanism where the stabilizer 620″′ is formed of sections which can collapse into each other upon retraction of the stabilizer 620″′. The stabilizer 620″′ is actively moving the lower end 620″′ of the stabilizer relative the crane trolley 603a. The stabilizer 620″′ may be driven up and down by a stabilizer motor 610 arranged at the crane trolley 603a. Independent drive of the stabilizer 620″′ provides for the possibility of increased acceleration of the lower end of the stabilizer, and thus the lifting frame, compared to the acceleration caused by gravity alone.

A lower end 620L″′ of the stabilizer 620′ is configured to interact with the lifting frame 504 in order to stabilize the lifting frame 504 during the first vertical movement range R1 of the lifting frame 504. The stabilizer 620″′ and the lifting frame 504 are configured to move vertically relative each other when in the second vertical movement range R2 of the lifting frame 504. The distance between the stabilizer 620″′ and the lifting frame 504 increases when the lifting frame 504 continues to move vertically below a reach of the lower end 620L″′ of the stabilizer 620″′.

The stabilizer 620″′ is configured to stabilize the lifting and lowering of the lifting frame 504 by guiding movement of the lifting frame 504 in a vertical direction below the crane trolley 603a while restricting horizontal movement of the lifting frame 504 during the first vertical movement range R1 of the lifting frame 504 when the lower end 620L″′ of the stabilizer 620″′ interacts with lifting frame 504. The lower end 620L″′ of the stabilizer 620″′ is fixedly connected to the stabilizer 620″′, i.e. the lower end 620L″′ of the stabilizer 620″′ moves together with the stabilizer 620″′.

Dependent on the use of the crane trolley assembly, the stabilizer 620″′ may have a maximum reach which is shorter than the maximum reach of the lifting members 505.

The first and second vertical movement ranges R1,R2 are subsequent movement ranges, i.e. the second vertical movement range R2 succeeds the first vertical movement range R1, and vice versa. In other words, the first and second vertical movement range R1,R2 do not overlap each other. The first vertical movement range is closer to the crane trolley relative the second vertical movement range R2.

The lifting frame 504 is preferably rectangular and comprises guides 506 at its corners for guiding the lifting frame 504 within storage columns 105 (not shown in FIG. 10, but see e.g. FIG. 11A) of a frame structure 100 (not shown in FIG. 10, but see e.g. FIG. 11A) of an automated storage and retrieval system 1 during the second vertical movement range R2. The guides 506 assist in aligning the grippers 508 relative the gripping recesses of the storage container 106.

The crane trolley 603a is disclosed with a first lateral movement arrangement 608 for movement along the first beam 601 and/or the second beam 602. The lateral movement arrangement 608 is shown as being in the form of wheels 608 which are driven by a first wheel motor 608′. The crane trolley 603a is thus be movable in a horizontal plane along the first beam 601 and/or the second beam 602.

The stabilizer 620″′ comprises an extendable mechanism for moving the lower end 620L″′ relative the crane trolley 603a. The extendable mechanism of the stabilizer 620″′ in FIG. 10s shown as a stabilizer 620″′ which can run through the crane trolley 603a.

The plurality of lifting members 505 are arranged to wind onto and off spools 611. The spools 611 are positioned at the lower end 620L″′ of the stabilizer 620″′. A lifting device motor 607 is also arranged at the lower end 620L″′ of the stabilizer 620″′.

FIGS. 11A and 11B are different views of an automated storage and retrieval system 1 comprising a first frame structure 100 having a first orientation and a second frame structure 100′ having a second orientation different from the first orientation, and a crane 600 spanning over the first and second frame structures 100,100′ with crane trolley assemblies 604″′ according to the third embodiment suspended from the crane 600. The second frame structure 100′ is oriented perpendicular to the first frame structure 100). The crane trolley assemblies 604″′ can transfer a storage container 106 between the first frame structure 100 and the second frame structure 100′ by rotating the lower end 620L″′ of the stabilizer 620″′ relative the stabilizer 620″′. As seen in the Figures, two of the access stations 150 (i.e. the access stations in connection with the second frame structure 100′), are oriented perpendicular to the access stations 150 in connection with the first frame structure 100 and a third frame structure 100″. Furthermore, the crane trolley assemblies 604″′ are adapted to lift and lower storage containers 106 from first type of container handling vehicles 30 operating on the rail system and transfer the storage containers 106 to different ports 150 wither within the same first frame structure 100 or to access stations 150 at any of the other second frame structure 100′ or third frame structure 100″, function as a buffer or temporary storage of frequently used storage containers 106, etc.

FIG. 11C is a top view of the automated storage and retrieval system in FIGS. 11A and 11B. As seen in FIG. 11C, the crane trolley assemblies 604″′ form part of the same crane 600, and because the crane 600 spans over all three frame structures 100,100′,100″′, the crane trolley assemblies 604″′ can move storage containers 106 between all three frame structures 100,100′,100″′. The rotation device of the crane trolley assembly 604″′ renders possible the transfer of the storage containers between the perpendicular oriented frame structures 100,100″ vs. 100′.

FIG. 11D is a perspective view of a first or second beam 601,602 with six crane trolley assemblies 604″′ according to the third embodiment suspended from the beam 601,602. The beam 601,602 features a second lateral movement arrangement 609 for moving the beam in a perpendicular direction relative the first lateral movement arrangement 608 (see e.g. FIG. 10). The second lateral movement arrangement 609 is shown as being in the form of wheels 609 which are driven by a second wheel motor 609′.

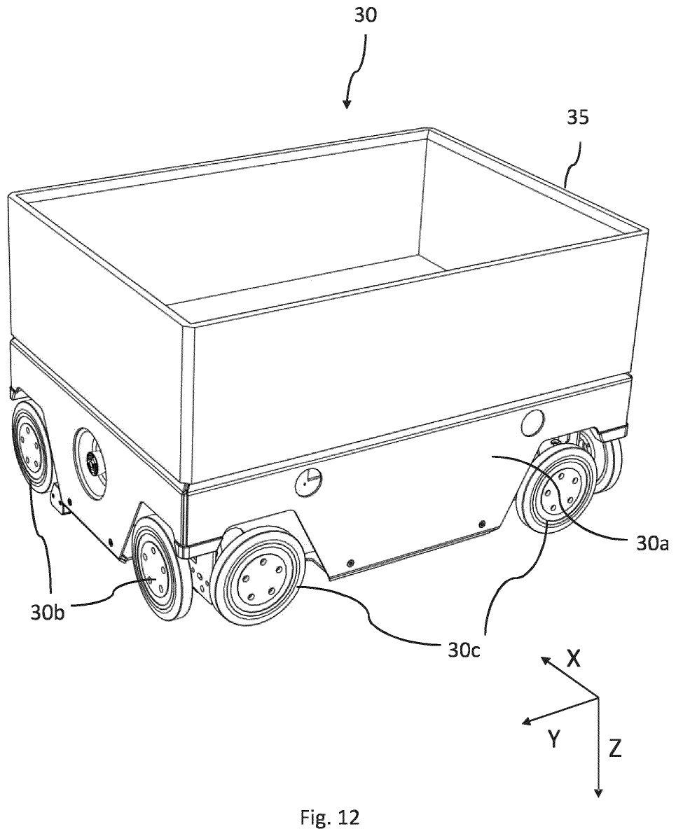

FIG. 12 is a side perspective view of an example first type of container handling vehicle 30 which can be used together with all of the three embodiments of the crane trolley assembly 604′,604″,604″′. The first type of container handling vehicle 30 is in the form of delivery vehicle 30 with a container carrier 35 for supporting a storage container 106. The container carrier 35 is configured to receive a storage container 106 from above. The delivery vehicle 30 comprises a vehicle body 30a. A first set of wheels 30b for movement on the rail system 108 in the first direction X as well as a second set of wheels 30c for movement on the rail system 108 in the second direction Y are mounted on the vehicle body of the delivery vehicle 30a.

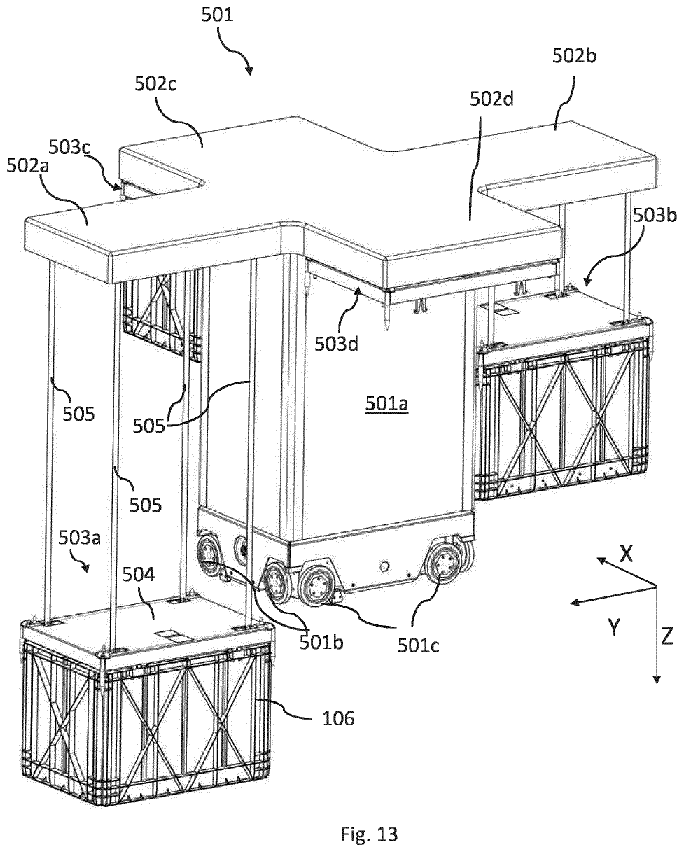

FIG. 13 shows an exemplary multi-cantilever container handling vehicle 501 which can operate on the rail system 108 together with the cranes 600 and other container handling vehicles.

The multi-cantilever container handling vehicle 501 is disclosed with four lifting devices 503a,503b,503c,503d. Each of the lifting devices 503a,503b,503c,503d are suspended from a respective cantilever section 502a,502b,502c,502d and comprises a lifting frame 504 suspended from lifting members 505.

As disclosed, the multi-cantilever container handling vehicle 501 features a first cantilever section 502a. The first lifting device 503a is suspended from the first cantilever section 502a. Furthermore, the multi-cantilever container handling vehicle 501 features a second cantilever section 502b on an opposite side of the vehicle body 501 of the multi-cantilever container handling vehicle 501 compared to the first cantilever section 502a. The second lifting device 503b is suspended from the second cantilever section 502b. As such, the multi-cantilever container handling vehicle 501 is configured to pick storage containers 106 from two different stacks 107 on different sides of the multi-cantilever container handling vehicle 501.

The multi-cantilever container handling vehicle 501 further features a third cantilever section 502c arranged perpendicular to the first cantilever section 502a and the second cantilever section 502b, and a third lifting device 503c suspended from the third cantilever section 502c; and a fourth cantilever section 502d arranged perpendicular to the first cantilever section 502a and the second cantilever section 502b on an opposite side of the body 501a compared to the third cantilever section 502c, and a fourth lifting device 503d suspended from the fourth cantilever section 502d.

The multi-cantilever container handling vehicles 501 are preferably configured to perform high-speed digging operations, however they are not designed to move fast between position A and position B on top of the rail system 108. The first type of container handling vehicle 30 however is not capable of perform digging but is rather designed with maximum stability in order to transfer storage containers fast between position A and position B on top of the rail system 108. The prior art cantilever container handling vehicles 301 pick up a storage container 106 from an underlying stack and bring the storage container 106 to the port area 50 themselves.

As such, in order for the system 1 to be effective, the multi-cantilever container handling vehicles 501 are preferably arranged at a relatively large distance from the port area 50 such that the first type of container handling vehicles 30 receive storage containers 106 from the multi-cantilever container handling vehicles 501 and transfer the storage containers to the port area 50, whereas the prior art cantilever container handling vehicles 301 are preferably arranged at a relatively close distance from the port area 50. Common to all of the three embodiments, the storage containers 106 can be arranged in a stack 107 of storage containers at the port area 50. Furthermore, in the event of e.g. “hot items”, i.e. items stored in storage containers 106 which are frequently used, such storage containers 106 can be arranged in a stack 107 of storage containers 106 within the port area 50 or they may be temporary stored in any of the lifting frames 504 of the crane 600.

In the preceding description, various aspects of the independent claims have been described. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention as defined in the attached claims.

### LIST OF REFERENCE NUMBERS

| | |
|---|---|
| 1 | Prior art automated storage and retrieval system |
| 30 | Delivery vehicle |
| 30a | Vehicle body delivery vehicle 30 |
| 30b | Drive means/wheel arrangement/first set of wheels in first direction (X) |
| 30c | Drive means/wheel arrangement/second set of wheels in second direction (Y) |
| 35 | Container carrier |
| 50 | Port area |
| 60 | Buffer stacks of storage containers |
| 100 | Frame structure/First frame structure |
| 100′ | Second frame structure |
| 100″ | Third frame structure |
| 102 | Upright member |
| 104 | Storage volume |
| 105 | Storage column |
| 106 | Storage container |
| 106′ | Particular position of storage container |
| 107 | Stack |
| 108 | Rail system |
| 110 | First set of parallel rails (in first direction (X)) |
| 111 | Second set of parallel rails (in second direction (Y)) |
| 112 | Access opening |
| 119 | Delivery column |
| 120 | Delivery column |
| 130 | Grid cell |
| 150 | Operator port |
| 201 | Prior art container handling vehicle |
| 201a | Vehicle body of the container handling vehicle 201 |
| 201b | Drive means/wheel arrangement/first set of wheels in first direction (X) |
| 201c | Drive means/wheel arrangement/second set of wheels in second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| 501 | Multi-cantilever container handling vehicle |
| 501a | Vehicle body of multi-cantilever container handling vehicle 501 |
| 501b | Drive means/first set of wheels in first direction (X) |
| 501c | Drive means/second set of wheels in second direction (Y) |
| 502a | First cantilever section |
| 502b | Second cantilever section |
| 502c | Third cantilever section |
| 502d | Fourth cantilever section |
| 503a | First lifting device of container handling vehicle 501 |
| 503b | Second lifting device of container handling vehicle 501 |
| 503c | Third lifting device of container handling vehicle 501 |
| 503d | Fourth lifting device of container handling vehicle 501 |
| 504 | Lifting frame |
| 505 | Lifting members/Lifting bands/Wire/Rope |
| 506 | Guide |
| 507 | Socket |
| 508 | Gripper |
| 600 | Crane/Gantry arrangement |
| 601 | First beam/First cross-member |
| 602 | Second beam/Second cross-member |
| 603a | First crane trolley |
| 603b | Second crane trolley |
| 603c | Third crane trolley |
| 603d | Fourth crane trolley |
| 603e | Fifth crane trolley |
| 603f | Sixth crane trolley |
| 604′, 604″, 604″′ | Crane trolley assembly |
| 607 | Lifting device motor |
| 608 | First lateral movement arrangement, wheels |
| 608′ | First wheel motor |
| 609 | Second lateral movement arrangement, wheels |
| 609′ | Second wheel motor |
| 610 | Stabilizer motor |
| 611 | Spool |
| 612 | Rotation device |
| 613 | Gear arrangement |
| 620′ | Stabilizer, first embodiment |
| 620″ | Stabilizer, second embodiment |
| 620″′ | Stabilizer, third embodiment |
| 620L′ | Lower end of stabilizer, first embodiment |
| 620L″ | Lower end of stabilizer, second embodiment |
| 620L″′ | Lower end of stabilizer, third embodiment |
| R1 | First vertical movement range |
| R2 | Second vertical movement range |
| X | First direction |
| Y | Second direction |
| Z | Third direction |

1-27. (canceled)

28. A crane trolley assembly comprising:
a crane trolley configured for guided movement along a beam of a crane;
a lifting frame configured for connection to a storage container to lift the storage container from above through a first vertical movement range and a second vertical movement range of the lifting frame;
a plurality of lifting members suspending the lifting frame below the crane trolley for lifting and lowering the lifting frame through at least the second vertical movement range; and
a stabilizer extending below the crane trolley, wherein a lower end of the stabilizer is configured to interact with the lifting frame in order to stabilize the lifting frame during the first vertical movement range of the lifting frame, and wherein the stabilizer and the lifting frame are configured to move vertically relative each other when in the second vertical movement range of the lifting frame.

29. The crane trolley assembly according to claim 28, wherein the stabilizer is configured to stabilize the lifting and lowering of the lifting frame by guiding movement of the lifting frame in a vertical direction below the crane trolley while restricting horizontal movement of the lifting frame during the first vertical movement range of the lifting frame when the lower end of the stabilizer interacts with the lifting frame.

30. The crane trolley assembly according to claim 28, wherein the lifting frame is rectangular and comprises guides at corners of the lifting frame for guiding the lifting frame within storage columns of a frame structure of an automated storage and retrieval system during the second vertical movement range.

31. The crane trolley assembly according to claim 28, wherein the beam is a first beam extending in a first direction or a second beam extending in a second direction perpendicular to the first direction, and wherein the crane trolley is movable along the first beam and/or the second beam; and
optionally:
wherein the crane trolley comprises a first lateral movement arrangement for movement along the first beam and/or the second beam.

32. The crane trolley assembly according to claim 28, wherein the stabilizer comprises an extendable mechanism for moving the lower end relative the crane trolley.

33. The crane trolley assembly according to claim 28, wherein the stabilizer extends through the crane trolley.

34. The crane trolley assembly according to claim 28, wherein the plurality of lifting members are arranged to wind onto and off spools.

35. The crane trolley assembly according to claim 34, wherein the spools are positioned at the crane trolley.

36. The crane trolley assembly according to claim 28, wherein the stabilizer is arranged between the lifting members.

37. The crane trolley assembly according to claim 28, wherein the lifting frame is provided with a socket to locate the lower end of the stabilizer, whereby sides of the socket engaging with the lower end of the stabilizer restrict horizontal movement of the lifting frame during the first vertical movement range.

38. The crane trolley assembly according to claim 34, wherein the spools are positioned at the lower end of the stabilizer; and optionally:
wherein the lower end of the stabilizer is fixedly connected to the stabilizer; or
wherein the lower end of the stabilizer is rotatably connected to the stabilizer, and optionally wherein the lower end comprises a rotation device for rotating the lower end of the stabilizer relative the stabilizer.

39. An automated storage and retrieval system comprising a two-dimensional rail system comprising a first set of parallel rails in a horizontal plane arranged to guide movement of container handling vehicles in a first direction across a top of a first frame structure formed by a plurality of upright members, and a second set of parallel rails in the horizontal plane arranged perpendicular to the first set of parallel rails to guide movement of the container handling vehicles in a second direction which is perpendicular to the first direction, the first frame structure defining a plurality of storage columns for accommodating vertical stacks of storage containers and a crane, the crane comprising a beam from which a crane trolley of a crane trolley assembly is suspended.

40. The automated storage and retrieval system according to claim 39, wherein:
a first vertical movement range of a lifting frame is represented by a first distance between the crane trolley assembly and the rail system; and
a second vertical movement range of the lifting frame is represented by a second distance between the rail system and a base of the first frame structure.

41. The automated storage and retrieval system according to claim 40, wherein the lifting frame is guided against a set of upright members from the plurality of upright members in its corners when in the second vertical movement range.

42. The automated storage and retrieval system according to claim 39, further comprising a second frame structure separated from the first frame structure, and wherein the crane spans over at least a part of the first frame structure and at least a part of the second frame structure.

43. The automated storage and retrieval system according to claim 42, wherein the second frame structure is oriented perpendicular to the first frame structure, and wherein the crane comprises a crane trolley and a stabilizer, wherein a lower end of the stabilizer comprises a rotation device for rotating the lower end of the stabilizer relative the stabilizer such that the crane trolley can transfer a storage container between the first frame structure and the second frame structure.

44. The automated storage and retrieval system according to claim 40, wherein the automated storage and retrieval system comprises:
a first type of container handling vehicle operating on the rail system, the first type of container handling vehicle comprises a first set of wheels for movement on the rail system in the first direction and a second set of wheels for movement on the rail system in the second direction, and a container carrier for supporting a storage container, the container carrier being configured to receive a storage container from above;
wherein the lifting frame is configured to be at a level above an uppermost part of a storage container carried by the container carrier of the first type of container handling vehicle when at least in an upper part of the first vertical movement range, such that the lifting frame can transfer a storage container between the container carrier and the column.

45. The automated storage and retrieval system according to claim 39, wherein the automated storage and retrieval system comprises a second type of container handling vehicle operating on the rail system, wherein the second type of container handling vehicle comprises a first set of wheels for movement on the rail system in the first direction and a second set of wheels for movement on the rail system in the second direction, and a first lifting device comprising a first lifting frame suspended from lifting members, wherein the first lifting frame is raisable at a level above an uppermost part of a storage container carried by a container carrier of the first type of container handling vehicle and is configured to transfer a storage container stored in a stack of storage containers to the container carrier of the first type of container handling vehicle.

46. The automated storage and retrieval system according to claim 39, wherein the crane further comprises:
at least two crane trolleys suspended from a same beam or a parallel beam.

47. A method of transferring a storage container between a container carrier of a first type of container handling vehicle and a column of the automated storage and retrieval system according to claim 39 using the crane, wherein the method comprises:
aligning the first type of container handling vehicle with a storage container arranged on the container carrier directly below a lifting frame of the crane;
lowering the lifting frame under guidance from a stabilizer in a downwards direction into contact with the storage container carried by the container carrier;
connecting the storage container to the lifting frame and lifting the storage container off the container carrier;
moving the first type of container handling vehicle to another location on the rail system;
lowering the lifting frame and thus the connected storage container into an access opening at a top of the column; and
lowering the lifting frame and the connected storage container by spooling out lifting members while the lifting frame is in a second vertical movement range guided by upright members of a frame structure.
